(19) United States
(12) Patent Application Publication
(10) Pub. No.: US 2021/0047235 A1
(43) Pub. Date: Feb. 18, 2021

(54) GLASS ARTICLES WITH ELONGATE MICROSTRUCTURES AND LIGHT EXTRACTION FEATURES

(71) Applicant: CORNING INCORPORATED, CORNING, NY (US)

(72) Inventors: Mandakini Kanungo, Painted Post, NY (US); Shenping Li, Painted Post, NY (US); Xiang-Dong MI, Pittsford, NY (US); Mark Alejandro Quesada, Horseheads, NY (US); Wageesha Senaratne, Horseheads, NY (US)

(21) Appl. No.: 16/969,401

(22) PCT Filed: Feb. 15, 2018
(86) PCT No.: PCT/US2018/018327

§ 371 Date: Aug. 12, 2020

Related U.S. Application Data
(60) Provisional application No. 62/629,358, filed on Feb. 12, 2018.

(51) Int. Cl. C03C 15/00; C03C 3/076; C03C 3/083; C03C 3/091; F21V 8/00

(52) U.S. Cl. CPC C03C 15/00; C03C 3/076; G02B 6/0036; C03C 3/091; G02B 6/0065; C03C 3/083

(57) ABSTRACT

Glass articles and glass light guide plates are disclosed that can be used in a backlight unit suitable for use as an illuminator for liquid crystal display devices. The glass article comprises a glass sheet including a first major surface comprising a plurality of channels or elongate microstructures, which can be separated by a non-zero spacing, the glass sheet further comprising a second major surface opposite the first major surface, and at least one of the first major surface and the second major surface comprising light extraction features formed therein. The glass article can be a light guide plate part of a backlight unit including a plurality of light emitting diodes arranged in an array along at least one edge surface of the glass sheet.

### CROSS-REFERENCE TO RELATED APPLICATION

This application claims the benefit of priority under 35 U.S.C. § 119 of U.S. Provisional Application Ser. No. 62/629,358 filed on Feb. 12, 2018, the content of which is relied upon and incorporated herein by reference in its entirety.

### BACKGROUND

The present disclosure relates generally to a glass articles which can be used in a backlight unit for illuminating a liquid crystal display device, and in particular a glass article that can be used as a backlight unit configured for one dimensional dimming and light extraction.

While organic light emitting diode display devices are gaining in popularity, costs are still high, and liquid crystal display (LCD) devices still comprise the large majority of display devices sold, particularly large panel size devices, such as television sets and other large-format devices such as commercial signs. Unlike OLED display panels, LCD panels do not themselves emit light, and are therefore dependent on a backlight unit (BLU) including a light guide plate (LGP) positioned behind the LCD panel to provide transmissive light to the LCD panel. Light from the BLU illuminates the LCD panel and the LCD panel functions as a light valve that selectively allows light to pass through pixels of the LCD panel or be blocked, thereby forming a viewable image.

Without augmentation, the native contrast ratio achievable with an LCD display is the ratio of the brightest portion of an image to the darkest portion of the image. The simplest contrast augmentation occurs by increasing the overall illumination for a bright image, and decreasing the overall illumination for a dark image. Unfortunately, this leads to muted brights in a dark image, and washed out darks in a bright image. To overcome this limitation, manufacturers can incorporate active local dimming of the image, wherein the illumination within predefined regions of the display can be locally dimmed relative to other regions of the display panel, depending on the image being displayed. Such local dimming can be relatively easily incorporated when the light source is positioned directly behind the LCD panel, for example a two dimensional array of LEDs. Local dimming is more difficult to incorporate with an edge lighted BLU, wherein an array of LEDs is arranged along an edge of a light guide plate incorporated into the BLU.

Typical light guide plates incorporate a polymer light guide, such as poly methyl methacrylate (PMMA). PMMA is easily formed, and can be molded or machined to facilitate local dimming. However, PMMA can suffer from thermal degradation, comprises a relatively large coefficient of thermal expansion, suffers from moisture absorption and is easily deformed. On the other hand, glass is dimensionally stable (comprises a relatively low coefficient of thermal expansion), and can be produced in large thin sheets suitable for the growing popularity of large, thin TVs.

Light is extracted from an LGP of a BLU such that its intensity and color is generally uniform across the LGP surface. Light extraction is typically achieved by modifying the surface of the LGP to destroy the total-internal-reflection (TIR) condition of the LGP to provide light extraction features. Typical techniques for modifying the surface of polymer or plastic LGPs to form light extraction features include: screen printing optically transparent inks containing particles (screen printing); inkjet printing of inks that form refractive lenslets on the LGP surface (inkjet printing); thermally imprinting features into the polymer; and laser melting/ablating refractive divots in the surface of the LGP (laser processing). In general, the area coverage of the surface modification should be low near the LEDs and high far from the LEDs to create uniform light extraction. With glass LGPs (GLGPs), however, there are challenges in using the above techniques. For example, stress introduced by thermal effects tends to cause unwanted micro cracks, which causes reliability issues and uncontrollable light scattering, therefore laser processing has not been successfully utilized to form light extraction patterns in GLGPs. Furthermore, because thinner LGPs require smaller extraction dots, screen and inkjet printing techniques are becoming more challenging for printing ideal extraction patterns on thin GLGPs which is desired by slim LCD displays.

Accordingly, it would be desirable to produce BLUs that include thin glass light guide plates capable of facilitating local dimming and light extraction.

### SUMMARY

Accordingly, a glass article is disclosed, the glass article comprising a glass sheet including a first major surface comprising a plurality of channels formed therein, wherein adjacent channels of the plurality of channels are separated by a non-zero distance W, at least one channel of the plurality of channels comprising a maximum depth H and a width S measured at one-half of the maximum depth (H/2) and comprising a ratio W/H in a range from about 1 to about 15. The glass sheet further comprising a second major surface opposite the first major surface, and at least one of the first major surface and the second major surface comprising light extraction features formed therein.

Another aspect pertains to a backlight unit, comprising glass article in accordance with any of the embodiments of the glass articles described herein, and further comprising a plurality of light emitting diodes arranged in an array along at least one edge surface of the glass sheet. Still another aspect pertains to an LCD display device comprising a backlight unit as described according to the various embodiments described herein.

Another aspect of the disclosure pertains to a method of manufacturing a light guide plate comprising forming a plurality of channels in a first major surface of a glass sheet further comprising a second major surface opposite the first major surface, wherein adjacent channels of the plurality of channels are separated by a non-zero distance W, at least one channel of the plurality of channels comprising a maximum depth H and a width S measured at one-half of the maximum depth (H/2) and comprising a ratio W/H in a range from about 1 to about 15; and forming a plurality of light extraction features in at least one of the first major surface and the second major surface.

Additional features of the embodiments disclosed herein will be set forth in the detailed description which follows, and in part will be readily apparent to those skilled in the art from that description or recognized by practicing embodiments as described herein, including the detailed description which follows, the claims, as well as the appended drawings.

The accompanying drawings are included to provide further understanding, and are incorporated into and constitute a part of this specification. The drawings illustrate various embodiments of the disclosure and together with the description serve to explain the principles and operations thereof.

### BRIEF DESCRIPTION OF THE DRAWINGS

FIG. 1 is a cross sectional view of an exemplary LCD display device;

FIG. 2 is a top view of an exemplary light guide plate;

FIG. 3A is a cross sectional view of a glass sheet comprising a plurality of channels in a surface thereof and suitable for use with the glass light guide plate of FIG. 2;

FIG. 3B is a cross sectional view of another glass sheet comprising a plurality of channels in a surface thereof and suitable for use with the glass light guide plate of FIG. 2;

FIG. 3C is a cross sectional view of still another glass sheet comprising a plurality of channels in a surface thereof and suitable for use with the glass light guide plate of FIG. 2;

FIG. 4A is a cross sectional view of a single channel formed in a major surface of a glass sheet;

FIG. 4B is a cross sectional view of a single channel formed in both major surfaces of a glass sheet;

FIG. 4C is a cross sectional view of a single channel formed in both major surfaces of a glass sheet having a low index material in the channel.

FIGS. 5A-C are cross sectional views of glass elongate microstructures on a major surface of a glass sheet;

FIGS. 6A-C are cross sectional views of glass elongate microstructures on both major surfaces of a glass sheet;

FIG. 7 is a diagram illustrating parameters for calculating LDI and straightness;

FIG. 8 is a graphical plot illustrating LDI as a function of channel wall angle for different channel depths;

FIG. 9A is a graphical plot illustrating LDI as a function of elongate microstructure spacing for a glass sheet comprising lenticular elongate microstructures on a single major surface;

FIG. 9B is a graphical plot illustrating straightness as a function of elongate microstructure spacing for a glass sheet comprising lenticular elongate microstructures on a single major surface;

FIG. 10A is a graphical plot illustrating LDI as a function of elongate microstructure spacing for a glass sheet comprising lenticular elongate microstructures on both major surfaces;

FIG. 10B is a graphical plot illustrating straightness as a function of elongate microstructure spacing for a glass sheet comprising lenticular elongate microstructures on both major surfaces;

FIG. 11A is a top view of an exemplary light guide plate;

FIG. 11B is a bottom view of an exemplary light guide plate;

FIG. 12A is a top view of an exemplary light guide plate;

FIG. 12B is a bottom view of an exemplary light guide plate;

FIG. 13A is a top view of an exemplary light guide plate;

FIG. 13B is a bottom view of an exemplary light guide plate;

FIG. 14A is a top view of an exemplary light guide plate;

FIG. 14B is a bottom view of an exemplary light guide plate;

FIG. 15A is a top view of an exemplary light guide plate;

FIG. 15B is an enlarged view of region “B” in FIG. 15A;

FIG. 15C is a cross sectional view of a glass sheet comprising a plurality of light extraction features therein;

FIG. 16 is a graphical plot illustrating extraction factor versus extraction line distance from input edge for achieving uniform light extraction in a LGP without reflector at the output edge for different power ratios of light going through the LGP to input light (Pout/Pin);

FIG. 17 is a graphical plot illustrating extraction factor versus extraction line distance from input edge for achieving uniform light extraction in a LGP with reflector at the output edge for different power ratios of light going through the LGP to input light (Pout/Pin);

FIG. 18 is a graphical plot illustrating extraction factor of one extraction line versus hole width for a LGP with different thicknesses;

FIG. 19 is a graphical plot illustrating extraction factor of one extraction line versus hole width for a LGP with different thicknesses;

FIG. 20A is a graphical plot illustrating extraction factor of one extraction line versus hole spacing for a LGP with different thicknesses;

FIG. 20B is a graphical plot illustrating extraction factor of one extraction line versus hole spacing for a LGP with different thicknesses;

FIG. 21 is a graphical plot illustrating extraction factor of one extraction line versus thickness;

FIG. 22A is a top view of an exemplary light guide plate;

FIG. 22B is a top view of an exemplary light guide plate;

FIG. 22C is a top view of an exemplary light guide plate;

FIGS. 23A-C are scanning electron micrographs of a sample made in accordance with Example 1; and

FIGS. 24A-C are scanning electron micrographs of a sample made in accordance with Example 2.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Current light guide plates used in LCD back light applications are typically formed with PMMA, as PMMA exhibits reduced optical absorption compared to many alternative materials. However, PMMA can present certain mechanical drawbacks that make the mechanical design of large size (e.g., 32 inch diagonal and greater) displays challenging. Such drawbacks include poor rigidity, high moisture absorption, and a relatively large coefficient of thermal expansion (CTE).

For example, conventional LCD panels are made of two pieces of thin glass (color filter substrate and TFT backplane), with the BLU comprising a PMMA light guide and a plurality of thin plastic films (diffusers, dual brightness enhancement films (DBEF) films, etc.) positioned behind the LCD panel. Due to the poor elastic modulus of PMMA, the overall structure of the LCD panel exhibits insufficient rigidity, and additional mechanical structure may be necessary to provide stiffness for the LCD panel, thereby adding mass to the display device. It should be noted that a Young's modulus of PMMA is generally about 2 GPa, while certain exemplary glasses can comprise a Young's modulus ranging from about 60 GPa to 90 GPa or more.

Humidity testing shows that PMMA is sensitive to moisture and can undergo dimensional changes by up to about 0.5%. Thus, for a PMMA panel with a length of one meter, a 0.5% change can increase the panel length by up to 5 mm, which is significant and makes the mechanical design of a corresponding BLU challenging. Conventional approaches to solve this problem include leaving an air gap between the LEDs and the PMMA LGP to allow the PMMA LGP to expand. However, light coupling between the LEDs and the LGP is extremely sensitive to the distance from the LEDs to the LGP, and the increased distance can cause display brightness to change as a function of humidity. Moreover, the greater the distance between LED and LGP, the less efficient the light coupling between the LED and LGP.

Still further, PMMA comprises a CTE of about 75E-6/° C., and comprises a relatively low thermal conductivity (approximately 0.2 W/m/K). In comparison, some glasses suitable for use as an LGP can comprise a CTE less than 8E-6/° C. with a thermal conductivity of 0.8 W/m/K or more. Accordingly, glass as a light guiding medium for BLUs offers superior qualities not found in polymer (e.g., PMMA) LGPs.

The proposed glass articles, glass light guide plates and methods for their manufacture described according to one or more embodiments enable direct formation and integral formation of both channels and light extraction features on GLGPs, and also enable simultaneous formation of light extraction features and local dimming optics on GLGPs. Because these is no added material (particularly, polymer materials) to form light extraction features and local dimming optics, compared with GLGPs with inject or screen printed extraction pattern, or the GLGPs with polymer added-on lenticular features, these all-glass-based LGPs are inherently more environmentally stable, more reliable, and exhibit lower color shift. Thus, in one or more embodiments, “all glass” articles are provided, meaning that the all glass articles comprise a glass sheet having elongate structures extending in a major plane (in the X-Y plane) of the sheet and light extraction features, wherein the elongate structures and the light extraction features are made from glass, and not made from polymeric materials. Such glass articles can be a light guide plate used in display applications.

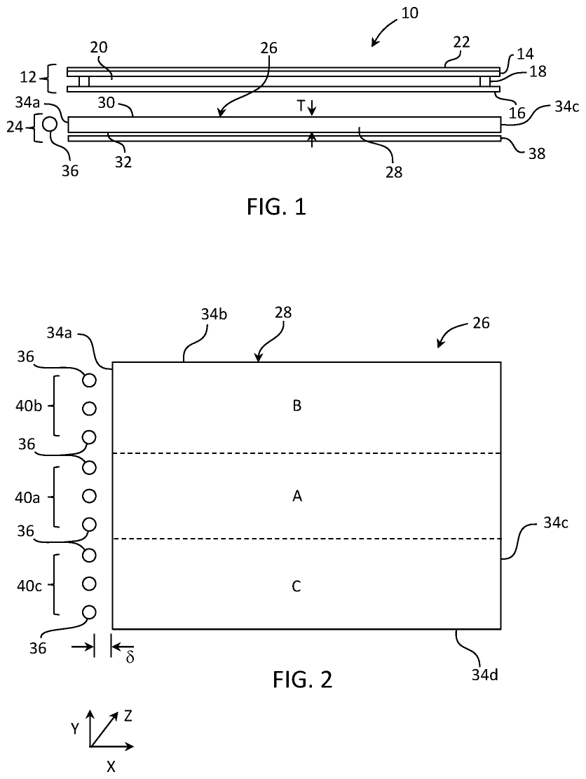

An exemplary LCD display device 10 is shown in FIG. 1 comprising an LCD display panel 12 formed from a first substrate 14 and a second substrate 16 joined by an adhesive material 18 positioned between and around a peripheral edge portion of the first and second substrates. First and second substrates 14, 16 and adhesive material 18 form a gap 20 therebetween containing liquid crystal material. Spacers (not shown) may also be used at various locations within the gap to maintain consistent spacing of the gap. First substrate 14 may include color filter material. Accordingly, first substrate 14 may be referred to as the color filter substrate. On the other hand, second substrate 16 includes thin film transistors (TFTs) for controlling the polarization state of the liquid crystal material, and may be referred to as the backplane. LCD panel 12 may further include one or more polarizing filters 22 positioned on a surface thereof.

LCD display device 10 further comprises BLU 24 arranged to illuminate LCD panel 12 from behind, i.e., from the backplane side of the LCD panel. In some embodiments, the BLU may be spaced apart from the LCD panel, although in further embodiments, the BLU may be in contact with or coupled to the LCD panel, such as with a transparent adhesive. BLU 24 comprises a glass light guide plate LGP 26 formed with a glass sheet 28 as the light guide, glass sheet 28 including a first major surface 30, a second major surface 32, and a plurality of edge surfaces extending between the first and second major surfaces. In embodiments, glass sheet 28 may be a parallelogram, for example a square or rectangle comprising four edge surfaces 34a, 34b, 34c and 34d as shown in FIG. 2 extending between the first and second major surfaces defining an X-Y plane of the glass sheet 28, as shown by the X-Y-Z coordinates. For example, edge surface 34a may be opposite edge surface 34c, and edge surface 34b may be positioned opposite edge surface 34d. Edge surface 34a may be parallel with opposing edge surface 34c, and edge surface 34b may be parallel with opposing edge surface 34d. Edge surfaces 34a and 34c may be orthogonal to edge surfaces 34b and 34d. The edge surfaces 34a-34d may be planar and orthogonal to, or substantially orthogonal (e.g., 90+/−1 degree, for example 90+/−0.1 degree) to major surfaces 30, 32, although in further embodiments, the edge surfaces may include chamfers, for example a planar center portion orthogonal to, or substantially orthogonal to major surfaces 30, 32 and joined to the first and second major surfaces by two adjacent angled surface portions.

First and/or second major surfaces 30, 32 may include an average roughness (Ra) in a range from about 0.1 nanometer (nm) to about 0.6 nm, for example less than about 0.6 nanometer (nm), less than about 0.5 nm, less than about 0.4 nm, less than about 0.3 nm, less than about 0.2 nm, or less than about 0.1 nm. An average roughness (Ra) of the edge surfaces may be equal to or less than about 0.05 micrometers (μm), for example in a range from about 0.005 micrometers to about 0.05 micrometers.

The foregoing level of major surface roughness can be achieved, for example, by using a fusion draw process or a float glass process followed by polishing. Surface roughness may be measured, for example, by atomic force microscopy, white light interferometry with a commercial system such as those manufactured by Zygo, or by laser confocal microscopy with a commercial system such as those provided by Keyence. The scattering from the surface may be measured by preparing a range of samples identical except for the surface roughness, and then measuring the internal transmittance of each. The difference in internal transmission between samples is attributable to the scattering loss induced by the roughened surface. Edge roughness can be achieved by grinding and/or polishing.

Glass sheet 28 further comprises a maximum thickness T in a direction orthogonal to first major surface 30 and second major surface 32. In some embodiments, thickness T may be equal to or less than about 3 mm, for example equal to or less than about 2 mm, or equal to or less than about 1 mm, although in further embodiments, thickness T may be in a range from about 0.1 mm to about 3 mm, for example in a range from about 0.1 mm to about 2.5 mm, in a range from about 0.3 mm to about 2.1 mm, in a range from about 0.5 mm to about 2.1 mm, in a range from about 0.6 to about 2.1, or in a range from about 0.6 mm to about 1.1 mm, including all ranges and subranges therebetween.

In various embodiments, the glass composition of glass sheet 28 may comprise between 60-80 mol % SiO₂, between 0-20 mol % Al₂O₃, and between 0-15 mol % B₂O₃, and comprise less than about 50 ppm iron (Fe) concentration. In some embodiments, there may be less than 25 ppm Fe, or in some embodiments the Fe concentration may be about 20 ppm or less. In various embodiments, the thermal conductivity of the glass sheet 28 may be greater than 0.5 W/m/K, for example in a range from about 0.5 to about 0.8 W/m/K. In additional embodiments, glass sheet 28 may be formed by a polished float glass, a fusion draw process, a slot draw process, a redraw process, or another suitable glass sheet forming process.

In some embodiments, glass sheet 28 comprises SiO₂ in a range from about 65.79 mol % to about 78.17 mol %, Al₂O₃ in a range from about 2.94 mol % to about 12.12 mol %, B₂O₃ in a range from 0 mol % to about 11.16 mol %, Li₂O in a range from 0 mol % to about 2.06 mol %, Na₂O in a range from about 3.52 mol % to about 13.25 mol %, M₂O in a range from 0 mol % to about 4.83 mol %, ZnO in a range from 0 mol % to about 3.01 mol %, MgO in a range from about 0 mol % to about 8.72 mol %, CaO in a range from about 0 mol % to about 4.24 mol %, SrO in a range from about 0 mol % to about 6.17 mol %, BaO in a range from about 0 mol % to about 4.3 mol %, and SnO₂ in a range from about 0.07 mol % to about 0.11 mol %. In some embodiments, the glass sheet can exhibit a color shift less than about 0.008, for example less than about 0.005. In some embodiments, the glass sheet comprises an RₓO/Al₂O₃ in a range from about 0.95 to about 3.23, wherein R is any one or more of Li, Na, K, Rb and Cs, and x is 2. In some embodiments, the glass sheet comprises an RₓO/Al₂O₃ between 1.18 and 5.68, wherein R is any one or more of Li, Na, K, Rb, Cs and x is 2, or Zn, Mg, Ca, Sr or Ba and x is 1. In some embodiments, the glass sheet comprises an RₓO—Al₂O₃—MgO in a range from about −4.25 to about 4.0, wherein R is any one or more of Li, Na, K, Rb and Cs, and x is 2.

In further embodiments, the glass sheet may comprise ZnO in a range from about 0.1 mol % to about 3.0 mol %, TiO₂ in a range from about 0.1 mol % to about 1.0 mol %, V₂O₃ in a range from about 0.1 mol % to about 1.0 mol %, Nb₂O₅ in a range from about 0.1 mol % to about 1.0 mol %, MnO in a range from about 0.1 mol % to about 1.0 mol %, ZrO₂ in a range from about 0.1 mol % to about 1.0 mol %, As₂O₃ in a range from about 0.1 mol % to about 1.0 mol %, SnO₂ in a range from about 0.1 mol % to about 1.0 mol %, MoO₃ in a range from about 0.1 mol % to about 1.0 mol %, Sb₂O₃ in a range from about 0.1 mol % to about 1.0 mol %, or CeO₂ in a range from about 0.1 mol % to about 1.0 mol %. In additional embodiments, the glass sheet may comprise between 0.1 mol % to no more than about 3.0 mol % of one or combination of any of ZnO, TiO₂, V₂O₃, Nb₂O₅, MnO, ZrO₂, As₂O₃, SnO₂, MoO₃, Sb₂O₃, and CeO₂.

In some embodiments, the glass sheet comprises a strain temperature in a range from about 522° C. to about 590° C. In some embodiments, the glass sheet comprises an annealing temperature in a range from about 566° C. to about 641° C. In some embodiments, the glass sheet comprises a softening temperature in a range from about 800° C. to about 914° C. In some embodiments, the glass sheet comprises a CTE in a range from about 49.6×10-7/° C. to about 80×10-7/° C. In some embodiments, the glass sheet comprises a density between about 2.34 gm/cc @ 20° C. and about 2.53 gm/cc @ 20° C. In some embodiments, the glass sheet comprises less than 1 ppm each of Co, Ni, and Cr. In some embodiments, the concentration of Fe is less than about 50 ppm, less than about 20 ppm, or less than about 10 ppm. In some embodiments, Fe+30Cr+35Ni is equal to or less than about 60 ppm, equal to or less than about 40 ppm, equal to or less than about 20 ppm, or equal to or less than about 10 ppm. In some embodiments, a transmittance of the glass sheet at 450 nm over a distance of at least 500 mm is greater than or equal to 85%, the transmittance at 550 nm over a distance of at least 500 mm is greater than or equal to 90%, or the transmittance at 630 nm over a distance of at least 500 mm is greater than or equal to 85%. In some embodiments, the glass sheet is a chemically strengthened glass sheet.

It should be understood, however, that embodiments described herein are not limited by glass composition, and the foregoing compositional embodiments are not limiting in that regard.

In accordance with embodiments described herein, BLU 24 further comprises an array of light emitting diodes (LEDs) 36 arranged along at least one edge surface (a light injection edge surface) of glass sheet 28, for example edge surface 34a. It should be noted that while the embodiment depicted in FIG. 1 shows a single edge surface 34a injected with light, the claimed subject matter should not be so limited, as any one or several of the edges of an exemplary glass sheet 28 can be injected with light. For example, in some embodiments, the edge surface 34a and its opposing edge surface 34c can both be injected with light. Additional embodiments may inject light at edge surface 34b and its opposing edge surface 34d rather than, or in addition to, the edge surface 34a and/or its opposing edge surface 34c. The light injection surface(s) may be configured to scatter light within an angle less than 12.8 degrees full width half maximum (FWHM) in transmission.

In some embodiments, LEDs 36 may be located a distance 8 from the light injection edge surface, e.g., edge surface 34a, of less than about 0.5 mm. According to one or more embodiments, LEDs 36 may comprise a thickness or height that is less than or equal to thickness T of glass sheet 28 to provide efficient light coupling into the glass sheet.

Light emitted by the array of LEDs is injected through the at least one edge surface 34a and guided through the glass sheet by total internal reflection, and extracted to illuminate LCD panel 12, for example by extraction features on one or both major surfaces 30, 32 of glass sheet 28. Such extraction features disrupt the total internal reflection, and cause light propagating within glass sheet 28 to be directed out of the glass sheet through one or both of major surfaces 30, 32. Accordingly, BLU 24 may further include a reflector plate 38 positioned behind glass sheet 28, opposite LCD panel 12, to redirect light extracted from the back side of the glass sheet, e.g., major surface 32, to a forward direction (toward LCD panel 12). Suitable light extraction features can include a roughed surface on the glass sheet, produced either by roughening a surface of the glass sheet directly, or by coating the sheet with a suitable coating, for example a diffusion film. Light extraction features in some embodiments can be obtained, for example, by printing reflective discrete regions (e.g., white dots) with a suitable ink, such as a UV-curable ink and drying and/or curing the ink. In some embodiments, combinations of the foregoing extraction features may be used, or other extraction features as are known in the art may be employed.

BLU may further include one or more films or coatings (not shown) deposited on a major surface of the glass sheet, for example a quantum dot film, a diffusing film, and reflective polarizing film, or a combination thereof.

Local dimming, e.g., one dimensional (1D) dimming, can be accomplished by turning on selected LEDs 36 illuminating a first region along the at least one edge surface 34a of glass sheet 28, while other LEDs 36 illuminating adjacent regions are turned off. Conversely, 1D local dimming can be accomplished by turning off selected LEDs illuminating the first region, while LEDs illuminating adjacent regions are turned on. FIG. 2 shows a portion of an exemplary LGP 26 comprising a first sub-array 40a of LEDs arranged along edge surface 34a of glass sheet 28, a second sub-array 40b of LEDs arranged along edge surface 34a of glass sheet 28, and a third sub-array 40c of LEDs 36 arranged along edge surface 34a of glass sheet 28. Three distinct regions of the glass sheet illuminated by the three sub-arrays are labeled A, B and C, wherein the A region is the middle region, and the B and C regions are adjacent the A region. Regions A, B and C are illuminated by LED sub-arrays 40a, 40b and 40c, respectively. With the LEDs of sub-array 40a in the “on” state and all other LEDs of other sub-arrays, for example the sub-arrays 40b and 40c, in the “off” state, a local dimming index LDI can be defined as 1−(average luminosity of the B, C regions)/(luminosity of the A region). A fuller explanation of determining LDI can be found, for example, in “Local Dimming Design and Optimization for Edge-Type LED Backlight Unit”: Jung, et al., SID 2011 Digest, 2011, pp. 1430-1432, the content of which is incorporated herein by reference in its entirety. It should be noted that the number of LEDs within any one array or sub-array, or even the number of sub-arrays, is at least a function of the size of the display device, and that the number of LEDs depicted in FIG. 2 are for illustration only and not intended as limiting. Accordingly, each sub-array can include a single LED, or more than one LED, or a plurality of sub-arrays can be provided in a number as necessary to illuminate a particular LCD panel, such as three sub-arrays, four sub-arrays, five sub-arrays, and so forth. For example, a typical 1D local dimming-capable 55″ (139.7 cm) LCD TV may have 8 to 12 zones. The zone width is typically in a range from about 100 mm to about 150 mm, although in some embodiments the zone width can be smaller. The zone length is about the same as a length of glass sheet 28.

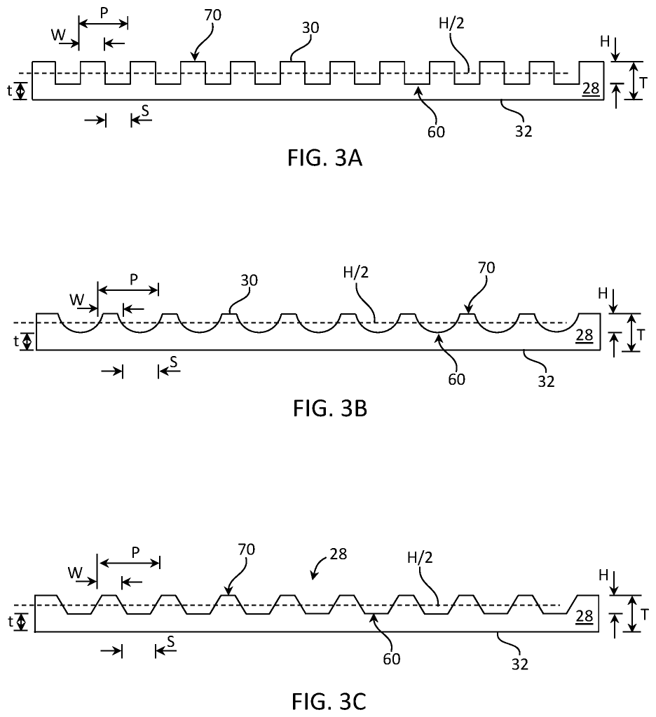

The glass sheet 28 can comprise a glass article described according to one or more embodiments herein, such as the non-limiting exemplary glass articles comprising a glass sheet as shown in FIGS. 3A-6C and FIGS. 11A-15C. Embodiments of glass articles comprising a glass sheet will now be described.

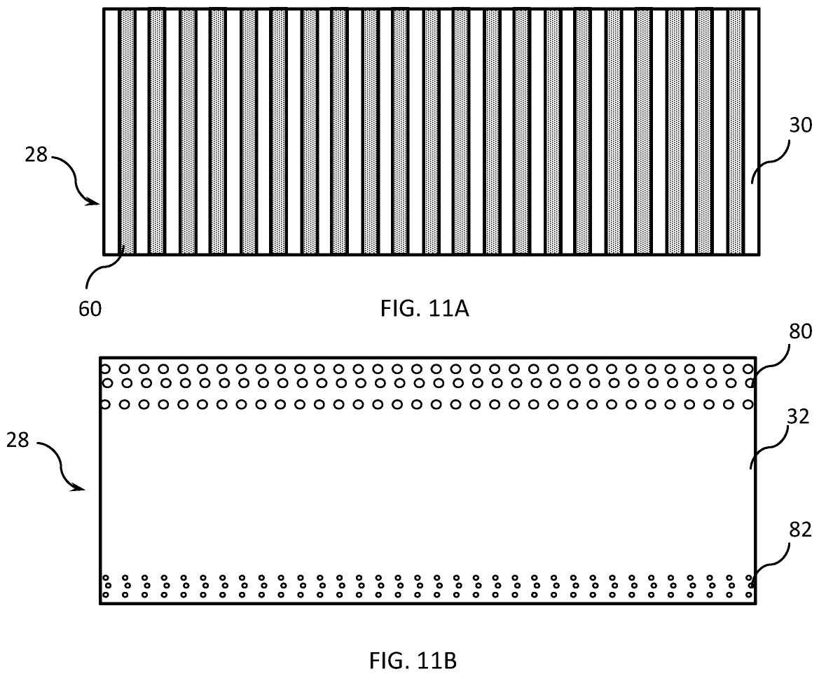

Referring now to FIG. 3A-3C, glass sheet 28 may be processed to include a plurality of channels 60 positioned in a surface of the glass sheet, for example first major surface 30, although in further embodiments, the plurality of channels may be formed in second major surface 32, or both first major surface 30 and second major surface 32. In some embodiments described below with respect to FIGS. 11A-24C, light extraction features may be formed in one or both of the first major surface 30 and the second major surface 32. In embodiments, each channel 60 of the plurality of channels 60 is substantially parallel to an adjacent channel of the plurality of channels 60, and comprises a maximum depth H and a width S defined at H/2 (the one-half the depth H of the channel), which is indicated by the line H/2 FIGS. 3A-C. Adjacent channels are separated by a distance W at H/2 (at one-half the maximum depth H of the channel). One or more channels 60 have a non-zero maximum depth H. For example, H can range from about 5 μm to about 300 μm, such as from about 10 μm to about 250 μm, from about 15 μm to about 200 μm, from about 20 μm to about 150 μm, from about 30 μm to about 100 μm, from about 20 μm to about 90 μm, f including all ranges and subranges there between, although other depths are also contemplated depending on the thickness T of the glass sheet and the cross sectional shape of the channels. In some embodiments, width W can range from about 10 μm to about 3 mm, such as from about 50 μm to about 2 mm, from about 100 μm to about 1 mm, from about 100 μm to about 900 μm, from about 100 μm to about 800 μm, from about 100 μm to about 700 μm, from about 100 μm to about 600 μm, from about 10 μm to about 500 μm, from about 25 μm to about 250 μm, or from about 50 μm to about 200 μm including all ranges and subranges therebetween, although other widths are also contemplated depending on the thickness T of the glass sheet and the cross sectional shape of the channels. The channels 60 may have a cross-sectional dimension S at H/2 (at one-half the maximum depth H of each channel).

The channels 60 may be periodic, with a period P=W+S, although in further embodiments, the channels may be non-periodic. Channels 60 may be of a variety of cross sectional shapes. For example, in the embodiment of FIG. 3A, channels 60 are of a rectangular shape in a cross section perpendicular to a longitudinal axis of each channel in the X-Y plane. In the embodiment of FIG. 3B, each channel 60 is of an arcuate cross sectional shape, for example a circular section, such as semicircular, while in the embodiment of FIG. 3C, each channel 60 comprises a trapezoidal cross-sectional shape. However, the cross sectional shapes of FIGS. 3A-3C are not limiting, and channels 60 may have other shapes, or combination of cross sectional shapes.

In some embodiments, a ratio W/H of each channel 60 of the plurality of channels is in a range from about 1 to about 15, for example in a range from about 2 to about 10, or in a range from about 2.5 to about 5, including all ranges and subranges therebetween. When W/H is greater than about 15, channels 60 can become ineffective for 1D local dimming. When W/H is less than about 1, channels 60 can be difficult to make and the glass is prone to breaking.

In addition, each channel 60 of the plurality of channels is separated from an adjacent channel of the plurality of channels at H/2 (at one half the maximum depth H) by a distance W. The distance W between adjacent channels at H/2 may, in various embodiments, correspond to the width of a local dimming zone for a backlight unit. Distance W can be, for example, equal to or greater than about 10 μm, equal to or greater than about 25 μm, equal to or greater than about 75 μm, equal to or greater than about 100 μm, equal to or greater than about 150 μm, equal to or greater than about 300 μm, equal to or greater than about 450 μm, equal to or greater than about 600 μm, equal to or greater than about 750 μm, equal to or greater than about 900 μm, equal to or greater than about 1200 μm, equal to or greater than about 1350 microns, equal to or greater than about 1500 μm, equal to or greater than about 1650 μm, equal to or greater than about 1800 μm, for example in a range from about 75 μm to about 1800 μm, depending on the thickness T of the glass sheet and the geometry of the channels 60. In some embodiments, a ratio W/S is in a range from about 0.1 to about 30, for example in a range from about 0.25 to about 10, for example in a range from about 0.5 to about 2, including all ranges and subranges therebetween.

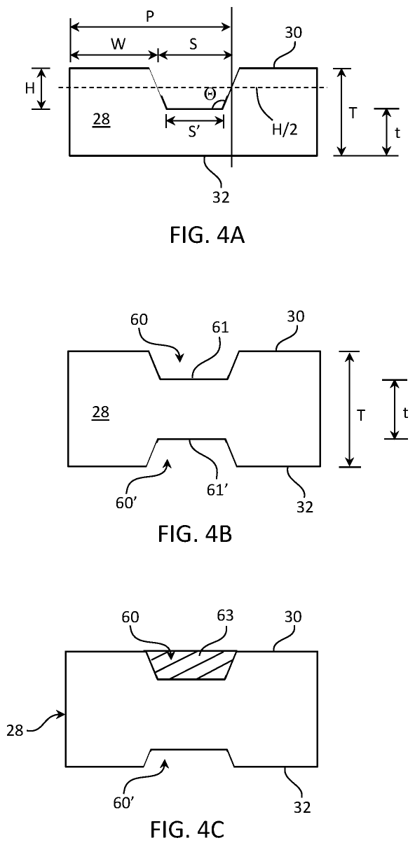

FIG. 4A depicts an enlarged view of a single channel 60 having a trapezoidal shape formed in the first major surface 30 of a glass sheet 28. As illustrated, the width S of the channel 60 at H/2 (one-half the maximum depth H) of each channel is greater than the minimum width S′ at the lower surface 61 of the trapezoid at the lowest point of first major surface 30. Of course, the orientation depicted in FIG. 4A can be rotated in any direction such that the terms “upper” and “lower” can be used interchangeably herein. FIG. 4B depicts an enlarged view of a two single channels 60, 60′ on opposing major surfaces 30, 32 of the glass sheet 28. The channel 60 on major surface 30 has a lower surface 61 at the lowest point of first major surface 30. The channel 60′ on major surface 32 has an upper surface 61′ at the highest point of the second major surface 32. Of course, the glass sheet 28 could be rotated 180 degrees such that 61′ would be a lower surface of channel 60′ and 61 would be an upper surface of channel 60. The channel maximum depth H can, in some embodiments, range from about 5% to about 90% of the glass sheet thickness T. For instance, in the embodiment depicted in FIG. 4A, e.g., a glass sheet with channels formed on only one major surface, the maximum channel depth H can range from about 1% to about 90% of the glass sheet thickness T (0.01≤H/T≤0.9), such as H/T≤0.9, H/T≤0.8, H/T≤0.7, H/T≤0.6, H/T≤0.5, H/T≤0.4, H/T≤0.3, H/T≤0.2, or H/T=0.1, including all ranges and subranges therebetween. In the embodiment depicted in FIG. 4B, e.g., a glass sheet with channels formed on both major surfaces, the maximum channel depth H can range from about 5% to about 45% of the glass sheet thickness T (0.05≤H/T≤0.45), such as H/T≤0.45, H/T≤0.4, H/T≤0.35, H/T≤0.3, H/T≤0.25, H/T≤0.2, H/T≤0.15, H/T≤0.1, or H/T=0.05, including all ranges and subranges therebetween. It is to be understood that the above ratios H/T can also be applied to embodiments with non-trapezoidal shapes, such as the rectangular and arcuate channels depicted in FIGS. 3A-B. In specific embodiments, H/T can be in a range of 0.01 to about 0.5, for example, 0.015 to about 0.3, and for example, and 0.02 to about 0.1.

Referring again to FIGS. 4A-B, the width S of the channel at H/2 (one half the maximum depth H) can range from about 10 μm to about 3 mm, such as from about 50 μm to about 2 mm, from about 100 μm to about 1 mm, from about 200 μm to about 900 μm, from about 300 μm to about 800 μm, from about 400 μm to about 700 μm, from about 500 μm to about 600 μm, from about 10 μm to about 1 mm, from about 50 μm to about 500 μm, or from about 100 μm to about 250 μm including all ranges and subranges therebetween. The minimum width S′ can similarly range from about 5 μm to about 2 mm, such as from about 10 μm to about 1 mm, from about 50 μm to about 900 μm, from about 100 μm to about 800 μm, from about 200 μm to about 700 μm, from about 300 μm to about 600 μm, from about 400 μm to about 500 μm, from about 5 μm to about 500 μm, from about 25 μm to about 250 μm, or from about 50 μm to about 125 μm including all ranges and subranges therebetween. According to various embodiments, the channel depth H can range from about 5 μm to about 300 μm, such as from about 10 μm to about 250 μm, from about 15 μm to about 200 μm, from about 20 μm to about 150 μm, from about 30 μm to about 100 μm, from about 40 μm to about 90 μm, from about 50 μm to about 80 μm, or from about 60 μm to about 70 μm, including all ranges and subranges therebetween. A glass sheet having a channel depth H will have a thickness T between the first major surface 30 and the second major surface 32, and a reduced thickness t extending from the second major surface 32 to the lowest surface 61 of the channel 60, as shown in FIG. 4A. In embodiments comprising channels 60 on the first major surface and channels 60′ on the second major surface 60, the reduced thickness t extends between the lowest surface of the channel 60

The wall angle Θ of the trapezoidal channel can also be varied to achieve a desired local dimming effect. The wall angle Θ can range, for instance, from greater than 90° to less than 180°, such as from about 95° to about 160°, from about 100° to about 150°, from about 110° to about 140°, or from about 120° to about 130°, including all ranges and subranges therebetween.

Referring now to FIG. 4C, in various embodiments, one or more channels 60 can be completely or partially filled with at least one low refractive index material 63, such as any optically transparent material having a refractive index at least 10% lower than that of the glass sheet. Exemplary low refractive index materials can be selected from polymers, glasses, inorganic oxides, and other like materials. The low refractive index material can be used to fill or partially fill channels of any shape and/or size, including the embodiments depicted in FIGS. 3A-C and 4A-B.

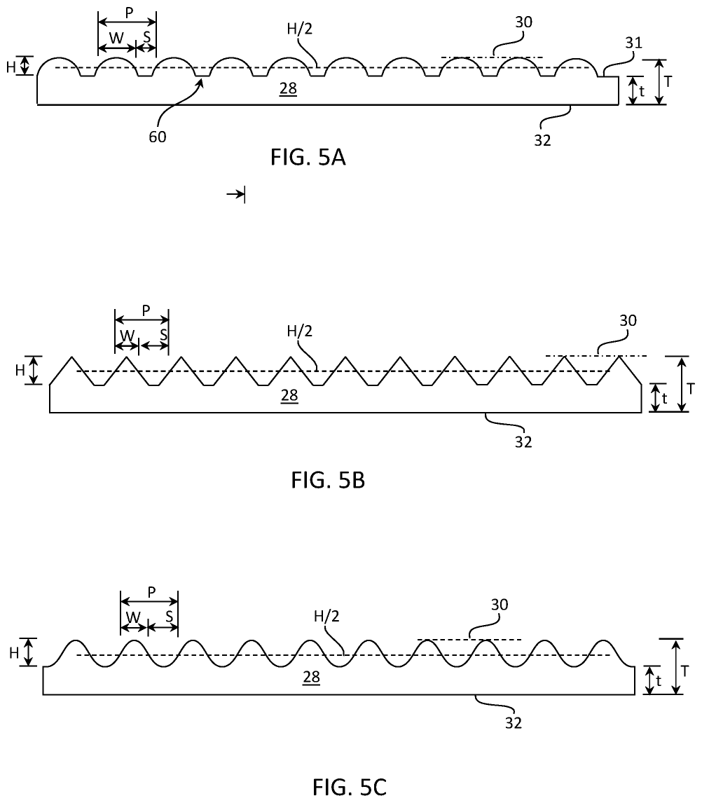

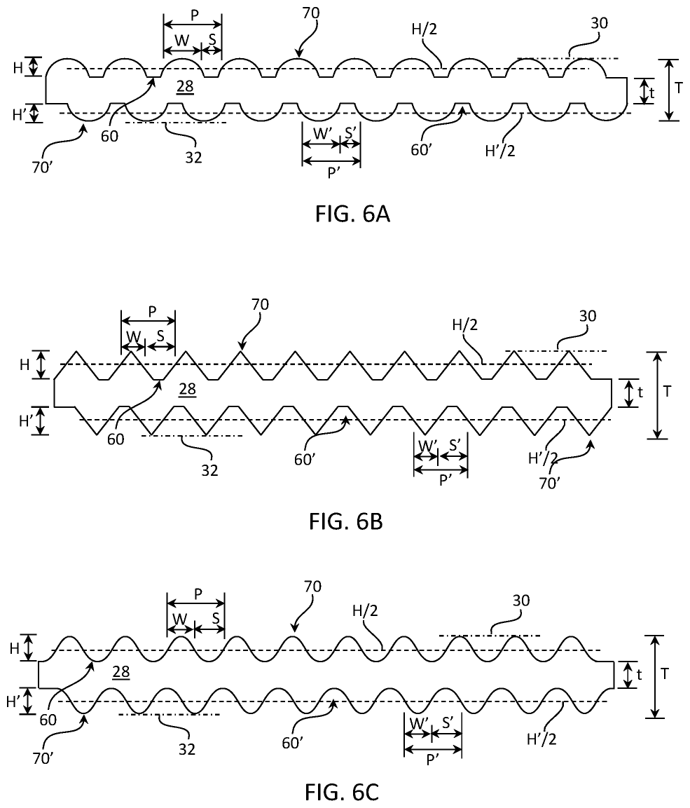

Referring now to FIGS. 5A-C, glass sheet 28 may be processed to provide a plurality of glass elongate microstructures 70 on a surface of the glass sheet, for example, first major surface 30 (as illustrated), although in further embodiments, the plurality of elongate microstructures may be formed on second major surface 32, or on both first major surface 30 and second major surface 32 (as illustrated in FIGS. 6A-C). In embodiments, each elongate microstructure 70 of the plurality of elongate microstructures comprises a maximum height H, which corresponds to the maximum depth of each channel 60. Thus, for the embodiments described above with respect to FIGS. 3A-C and 4A-C, the formation of channels 60 with a maximum depth H results in an elongate microstructure 70 having a maximum height that is equal to the maximum depth H of the channel. However, in some embodiments such as those shown in FIGS. 5A-C and 6A-C, the glass sheet is processed to form on the glass sheet the elongate microstructures 70 having the maximum height H, and between two elongate microstructures, a channel 60 is provided having a maximum depth that is equal to the maximum height H of each elongate microstructure 70. Each elongate microstructure 70 comprises a width W defined at H/2 (at one-half the maximum height H of each microstructure) as indicated by H/2 in FIGS. 5A-C. Each elongate microstructure 70 is formed on a major surface of the glass sheet (e.g., first major surface 30 or on second major surface 32). In one or more embodiments, “elongate” refers to the elongate microstructure having a length that extends along at least one of the first major surface 30 and the second major surface 32 between opposing edge surfaces, for example between edge surface 34a and edge surface 34c in the X-Y plane of the glass sheet 28. The elongate microstructures 70 may partially or fully extend across at least one of the first major surface 30 and the second major surface 32. In one or more embodiments, the length of the elongate microstructures from about 2 times distance between the edge surfaces 34a and edge surface 34c, As shown in FIGS. 5A-B, which depict lenticular and prismatic elongate microstructures, respectively, a spacing S may separate adjacent elongate microstructures 70. The spacing S is defined at one-half the maximum height H/2 of the elongate microstructures 70. Elongate microstructures 70 may be periodic, with a period P=W+S (both W and S taken at H/2), although in further embodiments, the elongate microstructures may be non-periodic.

One or more elongate microstructures 70 can have a non-zero height H. For example, H can range from about 5 μm to about 300 μm, such as from about 10 μm to about 250 μm, from about 15 μm to about 200 μm, from about 20 μm to about 150 μm, from about 30 μm to about 100 μm, from about 20 μm to about 90 μm, including all ranges and subranges there between. Other heights are also contemplated depending on the thickness T of the glass sheet and the cross sectional shape of the elongate microstructures. In some embodiments, width W can range from about 10 μm to about 3 mm, such as from about 50 μm to about 2 mm, from about 100 μm to about 1 mm, from about 100 μm to about 900 μm, from about 100 μm to about 800 μm, from about 100 μm to about 700 μm, from about 100 μm to about 600 μm, from about 10 μm to about 500 μm, from about 25 μm to about 250 μm, or from about 50 μm to about 200 μm including all ranges and subranges therebetween. Other widths are also contemplated depending on the thickness T of the glass sheet and the cross sectional shape of the elongate microstructures.

In some embodiments, a ratio W/H of each elongate microstructure 70 in the plurality of elongate microstructures ranges from about 1 to about 15, such as from about 2 to about 10, or from about 2.5 to about 5, including all ranges and subranges therebetween

When adjacent glass elongate microstructures 70 are separated by a spacing, the non-zero spacing S can be less than about four times the elongate microstructure width W at H/2, In addition, each channel 60 of the plurality of channels is separated from an adjacent channel of the plurality of channels at H/2 (at one half the maximum depth H) by a distance S. The distance S between adjacent channels at H/2 may, in various embodiments, correspond to the width of a local dimming zone for a backlight unit. Distance S can be, for example, equal to or greater than about 10 μm, equal to or greater than about 25 μm, equal to or greater than about 75 μm, equal to or greater than about 100 μm, equal to or greater than about 150 μm, equal to or greater than about 300 μm, equal to or greater than about 450 μm, equal to or greater than about 600 μm, equal to or greater than about 750 μm, equal to or greater than about 900 μm, equal to or greater than about 1200 μm, equal to or greater than about 1350 microns, equal to or greater than about 1500 μm, equal to or greater than about 1650 μm, equal to or greater than about 1800 μm, for example in a range from about 75 μm to about 1800 μm, depending on the thickness T of the glass sheet and the geometry of the channels 60.

When adjacent glass elongate microstructures 70′ on the second major surface as shown in FIGS. 6A-C are separated by a spacing, the non-zero spacing S′ can be less than about four times the elongate microstructure width W′ at H′/2, e. In the embodiments depicted in FIGS. 6A-C, e.g., when the first and second major surfaces both comprise a plurality of lenticular or prismatic elongate microstructures,

Channels 60 and elongate microstructures 70 may be formed, for example, by etching, wherein portions of first major surface 30 and/or second major surface 32 are coated with a suitable acid resistant material, for example by printing a resist material, and those portions of first major surface 30 and/or second major surface 32 where a channel is to be formed are maintained free of the acid resistant material. The coated surface may then be exposed to a suitable acid solution for a time and at a temperature necessary to etch the surface of the glass sheet to form channels or elongate microstructures having the desired depth or height and width, such as by dipping the glass sheet into the acid solution, or by spray etching with an acid solution. In embodiments where only a single major surface of the glass sheet is etched, the opposite major surface may be covered entirely with acid resistant material or suitable etch resistant protective film. Additionally, the edge surfaces may also be coated with acid resistant material. The acid solution may include, for example HF, H₂SO₄, HCl, and combinations thereof. The etching method may, in certain embodiments, be applicable to glass compositions having a viscosity η and Young's modulus of elasticity E, wherein η/E<0.5 seconds. The etching method can be used, for instance, to create any of the channels 60 or elongate microstructures 70 illustrated in FIGS. 3-6.

Channels 60 and elongate microstructures 70 may also be formed during a glass forming process, e.g., after formation of a glass ribbon but before cooling the ribbon to form a glass sheet. The glass ribbon prior to cooling may be viscous enough to be manipulated to create desired features. For instance, channels 60 or elongate microstructures 70 can be formed via manipulation of direct contact forces, e.g., using embossing rolls. The rolls can be machined to create the desired channels or elongate microstructures when impressed on the glass ribbon. In a viscous region of the glass forming process, the glass ribbon may be drawn through the rolls to create the desired channels or elongate microstructures. A transfer function may be used to describe the ratio between the machined features and resulting glass pattern which may, for example, account for contact forces, pulling forces, and viscous stretching or thermal expansion. The contact method may, in various embodiments, be applicable to glass compositions having a viscosity η and Young's modulus of elasticity E, wherein 0.0005 seconds <η/E<0.2 seconds. The contact method can be used, for instance, to create any of the channels 60 or elongate microstructures 70 illustrated in FIGS. 3-6.

Elongate microstructures 70 may additionally be formed on a surface of the glass ribbon by providing regions of local heating and cooling relative to the rest of the ribbon. Such regions may be produced, in some embodiments, by impinging the glass ribbon with hot and/or cold gas, e.g., air. The aspect ratio (W/H) of the elongate microstructures can be controlled by the method of heating or cooling, e.g., direct or indirect, by varying the orifice through which gas flows, and/or by varying the gas flow rate. Exemplary methods for locally heating or cooling the glass ribbon may employ, for instance, a hot sink tool, a lapinski tube, a doctari system located in a slide gate position, or other similar equipment. The local heating and/or cooling method may, in certain embodiments, be applicable to glass compositions having a viscosity 11 and Young's modulus of elasticity E, wherein 3.3×10⁻⁷ seconds <η/E<1.6×10⁻⁵ seconds. In some embodiments, the local heating/cooling method can be used to create the elongate microstructures 70 depicted in FIGS. 5-6.

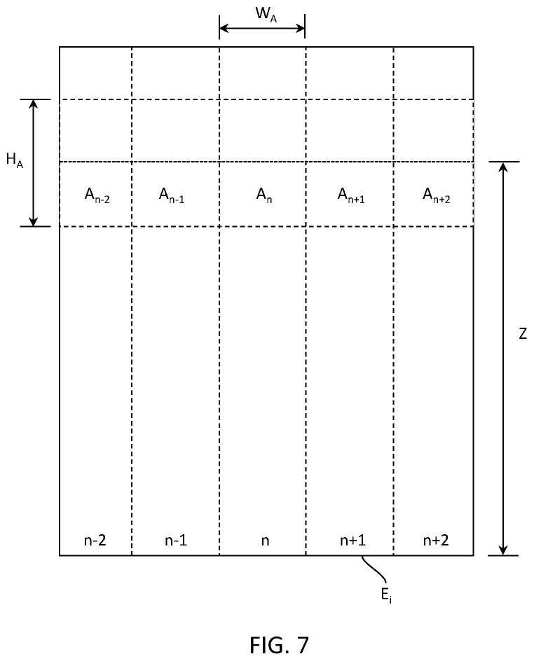

The performance of local dimming optics for 1D light confinement can be evaluated by two parameters: LDI and straightness. As shown in FIG. 7, LDI and straightness at a distance Z from a LED input edge Eᵢ can respectively be defined as:

$$\begin{matrix}LDI = [ 1 - \frac{( {L}_{n + 1} + {L}_{n - 1} ) \text{/} 2}{{L}_{n}} ] \times 100 & ( 1 ) \\ Straightness = \frac{( {L}_{n - 2} + {L}_{n + 2} ) \text{/} 2}{{L}_{n}} \times 100 & ( 2 )\end{matrix}$$

where, Lₘ is the luminance of the area A. of zone m (m=n−2, n−1, n, n+1, n+2) at the distance Z from LED input edge. Each area Aₘ can be defined by a width W_{A} and a height H_{A}.

Table 1 shows the calculated LDI for modeled channels of various configurations for two glass sheets of 1.1 mm and 2.1 mm thickness and a variety of different W/H values but the same W/S value. All H, W and S values are given in micrometers (μm). Glass sheets with an LDI greater than 0.70 were considered to be passing (acceptable), wherein glass sheets with an LDI equal to or less than 0.70 were considered to be failing. It should be noted, however, that 0.70 as a cut off between pass and fail is somewhat subjective, and may vary depending on specific application and need. For example, in some applications, LDI can be less than 0.70.

Data for a stepped cross sectional shape is provided in Table 1A, while data for an arcuate cross sectional shape (e.g., circular section channel) is provided in Table 1B. The data show that, as the depth of the channels (H) increases, LDI also increases. The data show that, as glass sheet thickness decreases, channels with a smaller H/S ratio become effective enough to meet requirements for 1D local dimming (LDI value >0.7), while channels with the same H/S ratios made on thicker glass are not effective enough for 1D local dimming. This advantage is not readily available for PMMA or other plastic-based light guides, as thin PMMA suffers from low mechanical strength and high thermal expansion for large sized TV application. All H, S and W values are given in micrometers in Tables 1A-4B.

TABLE 1A

| | | | | | | T = 1.1 mm | | T = 2.1 mm | |
|---|---|---|---|---|---|---|---|---|---|
| | | | | | | Step | | Step | |
| H | S | W | H/S | W/S | W/H | LDI | | LDI | |
| 45 | 150 | 150 | 0.3 | 1 | 3.33 | 0.83 | Pass | 0.78 | Pass |
| 40 | 150 | 150 | 0.27 | 1 | 6.67 | 0.82 | Pass | 0.77 | Pass |
| 35 | 150 | 150 | 0.23 | 1 | 10.00 | 0.82 | Pass | 0.77 | Pass |
| 30 | 150 | 150 | 0.2 | 1 | 13.33 | 0.82 | Pass | 0.76 | Pass |
| 25 | 150 | 150 | 0.17 | 1 | 16.67 | 0.78 | Pass | 0.74 | Pass |
| 20 | 150 | 150 | 0.13 | 1 | 20.00 | 0.79 | Pass | 0.70 | Pass |
| 15 | 150 | 150 | 0.1 | 1 | 23.33 | 0.76 | Pass | 0.71 | Pass |
| 10 | 150 | 150 | 0.07 | 1 | 26.67 | 0.72 | Pass | 0.65 | Fail |
| 5 | 150 | 150 | 0.03 | 1 | 30.00 | 0.65 | Fail | 0.58 | Fail |
| 0 | 150 | 150 | 0 | 1 | 33.33 | 0.36 | Fail | 0.28 | Fail |

TABLE 1B

| | | | | | | T = 1.1 mm | | T = 2.1 mm | |
|---|---|---|---|---|---|---|---|---|---|
| | | | | | | Arcuate | | Arcuate | |
| H | S | W | H/S | W/S | W/H | LDI | | LDI | |
| 45 | 115.2 | 184.8 | 0.39 | 1.60 | 4.11 | 0.85 | Pass | 0.76 | Pass |
| 40 | 113.4 | 186.6 | 0.35 | 1.65 | 4.67 | 0.84 | Pass | 0.74 | Pass |
| 35 | 111.7 | 188.3 | 0.31 | 1.69 | 5.38 | 0.81 | Pass | 0.71 | Pass |
| 30 | 110.2 | 189.8 | 0.27 | 1.72 | 6.33 | 0.77 | Pass | 0.66 | Fail |
| 25 | 109.0 | 191.0 | 0.23 | 1.75 | 7.64 | 0.72 | Pass | 0.59 | Fail |
| 20 | 107.9 | 192.1 | 0.19 | 1.78 | 9.60 | 0.64 | Fail | 0.50 | Fail |
| 15 | 107.1 | 192.9 | 0.14 | 1.80 | 12.86 | 0.53 | Fail | 0.40 | Fail |
| 10 | 106.5 | 193.5 | 0.09 | 1.82 | 19.35 | 0.36 | Fail | 0.32 | Fail |
| 5 | 106.2 | 193.8 | 0.05 | 1.83 | 38.76 | 0.34 | Fail | 0.23 | Fail |
| 0 | 106.1 | 193.9 | 0 | 1.83 | — | 0.36 | Fail | 0.28 | Fail |

Tables 2A (step) and 2B (arcuate) below show the calculated LDI of glass sheets comprising channels with different W/S ratios but the same H/S ratios for 1.1 mm and 2.1 mm thick glass sheets resulting from varying the peak width W between channels. The channels themselves remained consistent. For channels with the same depth to width ratio H/S but varying the peak width W and therefore varying the W/S ratio, the 1.1 mm thick glass sheet shows better LDI than the 2.1 mm thick glass sheet. The data further show that as the glass sheet thickness becomes smaller, channels with a larger W/S ratio become effective enough (with LDI>0.7) for 1D local dimming.

TABLE 2A

| | | | | | | T = 1.1 mm | | T = 2.1 mm | |
|---|---|---|---|---|---|---|---|---|---|
| | | | | | | Step | | Step | |
| H | S | W | H/S | W/S | W/H | LDI | | LDI | |
| 45 | 150 | 150 | 0.3 | 1 | 3.33 | 0.83 | Pass | 0.78 | Pass |
| 45 | 150 | 300 | 0.3 | 2 | 6.67 | 0.83 | Pass | 0.78 | Pass |
| 45 | 150 | 450 | 0.3 | 3 | 10.00 | 0.81 | Pass | 0.75 | Pass |
| 45 | 150 | 600 | 0.3 | 4 | 13.33 | 0.78 | Pass | 0.70 | Fail |
| 45 | 150 | 750 | 0.3 | 5 | 16.67 | 0.78 | Pass | 0.72 | Pass |
| 45 | 150 | 900 | 0.3 | 6 | 20.00 | 0.75 | Pass | 0.71 | Pass |
| 45 | 150 | 1050 | 0.3 | 7 | 23.33 | 0.76 | Pass | 0.67 | Fail |
| 45 | 150 | 1200 | 0.3 | 8 | 26.67 | 0.71 | Pass | 0.63 | Fail |
| 45 | 150 | 1350 | 0.3 | 9 | 30.00 | 0.73 | Pass | 0.65 | Fail |
| 45 | 150 | 1500 | 0.3 | 10 | 33.33 | 0.73 | Pass | 0.62 | Fail |
| 45 | 150 | 1650 | 0.3 | 11 | 36.67 | 0.71 | Pass | 0.63 | Fail |
| 45 | 150 | 1800 | 0.3 | 12 | 40.00 | 0.71 | Pass | 0.63 | Fail |
| 45 | 150 | 1950 | 0.3 | 13 | 43.33 | 0.70 | Fail | 0.58 | Fail |

TABLE 2B

| | | | | | | T = 1.1 mm | | T = 2.1 mm | |
|---|---|---|---|---|---|---|---|---|---|
| | | | | | | Arcuate | | Arcuate | |
| H | S | W | H/S | W/S | W/H | LDI | | LDI | |
| 45 | 115.2 | 184.8 | 0.39 | 1.60 | 4.11 | 0.85 | Pass | 0.76 | Pass |
| 45 | 115.2 | 334.8 | 0.39 | 2.91 | 7.44 | 0.83 | Pass | 0.72 | Pass |
| 45 | 115.2 | 484.8 | 0.39 | 4.21 | 10.77 | 0.78 | Pass | 0.69 | Fail |
| 45 | 115.2 | 634.8 | 0.39 | 5.51 | 14.11 | 0.75 | Pass | 0.62 | Fail |
| 45 | 115.2 | 784.8 | 0.39 | 6.81 | 17.44 | 0.73 | Pass | 0.61 | Fail |
| 45 | 115.2 | 934.8 | 0.39 | 8.11 | 20.77 | 0.70 | Fail | 0.60 | Fail |
| 45 | 115.2 | 1084.8 | 0.39 | 9.42 | 24.11 | 0.70 | Fail | 0.57 | Fail |
| 45 | 115.2 | 1234.8 | 0.39 | 10.72 | 27.44 | 0.68 | Fail | 0.55 | Fail |
| 45 | 115.2 | 1384.8 | 0.39 | 12.02 | 30.77 | 0.65 | Fail | 0.53 | Fail |
| 45 | 115.2 | 1534.8 | 0.39 | 13.32 | 34.11 | 0.66 | Fail | 0.52 | Fail |
| 45 | 115.2 | 1684.8 | 0.39 | 14.62 | 37.44 | 0.64 | Fail | 0.44 | Fail |
| 45 | 115.2 | 1834.8 | 0.39 | 15.92 | 40.77 | 0.63 | Fail | 0.48 | Fail |
| 45 | 115.2 | 1984.8 | 0.39 | 17.23 | 44.11 | 0.59 | Fail | 0.45 | Fail |

Table 3A (step) and Table 3B (arcuate), and Table 4A (step) and Table 4B (arcuate) below show calculated LDI for glass sheets comprising channels for a 0.6 mm thick glass sheet as a result of varying channel depth. For channels with the same W/S ratio but with a varying H/S ratio as a result of varying channel depth H, the 0.6 mm thick glass sheet shows better LDI than either one of the 1.1 mm or 2.1 mm thick glass sheets presented in Tables 1A, 1B and 2A, 2B for the same values of H, S and W. All H, S and W values are given in micrometers.

Tables 4A and 4B present modeled data for the same glass sheet as Tables 3A, 3B, but assume a peak width W and channel width S that are one half the peak width W and channel width S assumed in Tables 3A and 3B. Comparing Tables 3A, 3B with Table 4A, 4B, a decreased period P exhibits similar behavior. All H, S and W values are given in micrometers.

TABLE 3A

| | | | | | | T = 0.6 mm | |
|---|---|---|---|---|---|---|---|
| | | | | | | Step | |
| H | S | W | H/S | W/S | W/H | LDI | |
| 45 | 150 | 150 | 0.3 | 1 | 3.33 | 0.89 | Pass |
| 40 | 150 | 150 | 0.27 | 1 | 3.75 | 0.88 | Pass |
| 35 | 150 | 150 | 0.23 | 1 | 4.29 | 0.88 | Pass |
| 30 | 150 | 150 | 0.2 | 1 | 5.00 | 0.87 | Pass |
| 25 | 150 | 150 | 0.17 | 1 | 6.00 | 0.86 | Pass |
| 20 | 150 | 150 | 0.13 | 1 | 7.50 | 0.83 | Pass |
| 15 | 150 | 150 | 0.1 | 1 | 10.00 | 0.83 | Pass |
| 10 | 150 | 150 | 0.07 | 1 | 15.00 | 0.79 | Pass |
| 5 | 150 | 150 | 0.03 | 1 | 30.00 | 0.70 | Fail |
| 0 | 150 | 150 | 0 | 1 | — | 0.36 | Fail |

TABLE 3B

| | | | | | | T = 0.6 mm | |
|---|---|---|---|---|---|---|---|
| | | | | | | Arcuate | |
| H | S | W | H/S | W/S | W/H | LDI | |
| 45 | 115.2 | 184.8 | 0.39 | 1.60 | 4.11 | 0.85 | Pass |
| 40 | 113.4 | 186.6 | 0.35 | 1.65 | 4.67 | 0.84 | Pass |
| 35 | 111.7 | 188.3 | 0.31 | 1.69 | 5.38 | 0.81 | Pass |
| 30 | 110.2 | 189.8 | 0.27 | 1.72 | 6.33 | 0.77 | Pass |
| 25 | 109.0 | 191.0 | 0.23 | 1.75 | 7.64 | 0.72 | Pass |
| 20 | 107.9 | 192.1 | 0.19 | 1.78 | 9.60 | 0.64 | Fail |
| 15 | 107.1 | 192.9 | 0.14 | 1.80 | 12.86 | 0.53 | Fail |
| 10 | 106.5 | 193.5 | 0.09 | 1.82 | 19.35 | 0.36 | Fail |
| 5 | 106.2 | 193.8 | 0.05 | 1.83 | 38.76 | 0.34 | Fail |
| 0 | 106.1 | 193.9 | 0.00 | 1.83 | — | 0.36 | Fail |

TABLE 4A

| | | | | | | |
|---|---|---|---|---|---|---|
| | | | | | | T = 0.6 mm |
| | | | | | | Step |
| H | S | W | H/S | W/S | W/H | LDI |

| | | | | | | | |
|---|---|---|---|---|---|---|---|
| 45 | 75 | 75 | 0.6 | 1 | 1.67 | 0.92 | Pass |
| 40 | 75 | 75 | 0.53 | 1 | 1.88 | 0.91 | Pass |
| 35 | 75 | 75 | 0.47 | 1 | 2.14 | 0.91 | Pass |
| 30 | 75 | 75 | 0.4 | 1 | 2.50 | 0.89 | Pass |
| 25 | 75 | 75 | 0.3 | 1 | 3.00 | 0.89 | Pass |
| 20 | 75 | 75 | 0.27 | 1 | 3.75 | 0.89 | Pass |
| 15 | 75 | 75 | 0.2 | 1 | 5.00 | 0.86 | Pass |
| 10 | 75 | 75 | 0.13 | 1 | 7.50 | 0.84 | Pass |
| 5 | 75 | 75 | 0.067 | 1 | 15.00 | 0.80 | Pass |
| 0 | 75 | 75 | 0 | 1 | — | 0.36 | Fail |

TABLE 4B

| | | | | | | T = 0.6 mm | |
|---|---|---|---|---|---|---|---|
| | | | | | | Arcuate | |
| H | S | W | H/S | w/s | W/H | LDI | |
| 45 | 69.6 | 80.4 | 0.65 | 1.16 | 1.79 | 0.92 | Pass |
| 40 | 66.4 | 83.6 | 0.60 | 1.26 | 2.09 | 0.92 | Pass |
| 35 | 63.5 | 86.5 | 0.55 | 1.36 | 2.47 | 0.92 | Pass |
| 30 | 60.9 | 89.1 | 0.49 | 1.46 | 2.97 | 0.91 | Pass |
| 25 | 58.6 | 91.4 | 0.43 | 1.56 | 3.65 | 0.89 | Pass |
| 20 | 56.7 | 93.3 | 0.35 | 1.65 | 4.67 | 0.89 | Pass |
| 15 | 55.1 | 94.9 | 0.27 | 1.72 | 6.33 | 0.85 | Pass |
| 10 | 54.0 | 96.0 | 0.19 | 1.78 | 9.60 | 0.75 | Pass |
| 5 | 53.3 | 96.7 | 0.09 | 1.82 | 19.35 | 0.47 | Fail |
| 0 | 53.0 | 97.0 | 0.00 | 1.83 | — | 0.36 | Fail |

Table 5 below shows LGP, LED, and channel parameters for a backlight unit comprising a glass sheet with trapezoidal channels formed in a single major surface (see FIGS. 3C, 4A).

TABLE 5

| | |
|---|---|
| LGP thickness T (mm) | 1.1 |
| LGP width (mm) | 500 |
| LGP length (mm) | 1000 |
| Channel period P (mm) | 100 |
| Channel bottom width S′ (μm) | 10 |
| Local dimming zone width (mm) | 100 |
| LEDs in a single local dimming zone | 10 |
| LED-LGP gap (mm) | 0.01 |
| LED width (mm) | 1.0 |
| LED length (mm) | 3.6 |

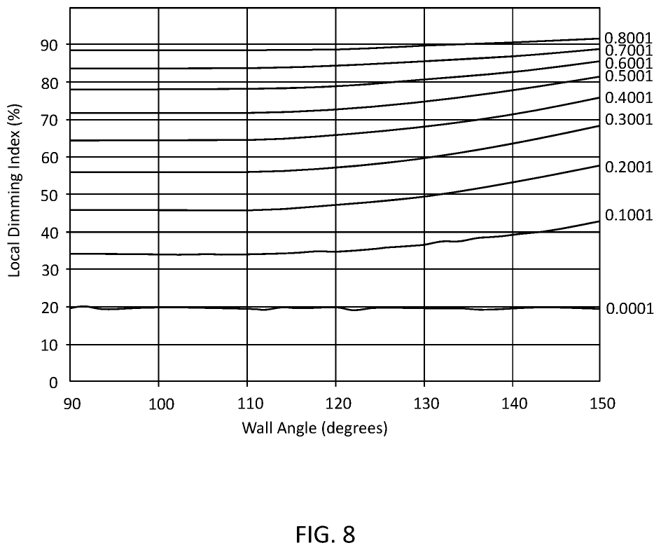

FIG. 8 plots LDI at a 300 mm distance from the light input edge as a function of channel wall angle Θ for different channel depths (A=0.8001 mm, B=0.7001 mm, C=0.6001 mm, D=0.5001 mm, E=0.4001 mm, F=0.3001 mm, G=0.2001 mm, H=0.1001 mm, J=0.0001 mm). As illustrated by the plot, LDI increases as the channel depth increases. LDI also increases as the wall angle Θ increases. The impact of the wall angle Θ becomes stronger with increasing channel depth. For the above parameters, LDI of 75% or greater can be achieved using a channel depth of at least about 0.4 mm (plot E) and a wall angle of at least about 150°. Similar LDI values can be achieved with smaller wall angles using greater channel depths (see plots A-D).

Table 6 below shows LGP, LED, and elongate microstructure parameters for a backlight unit comprising a glass sheet with lenticular elongate microstructures on a single major surface (see FIG. 5A).

TABLE 6

| | |
|---|---|
| LGP thickness T (mm) | 1.1 |
| LGP width (mm) | 500 |
| LGP length (mm) | 750 |
| LGP refractive index | 1.50 |
| Lenticular width W (mm) | 0.886 |
| Lenticular height H (mm) | 0.15 |
| Local dimming zone width (mm) | 150 |
| LEDs in a single local dimming zone | 10 |
| LED-LGP gap (mm) | 0.01 |
| LED width (mm) | 1.0 |
| LED length (mm) | 4.5 |

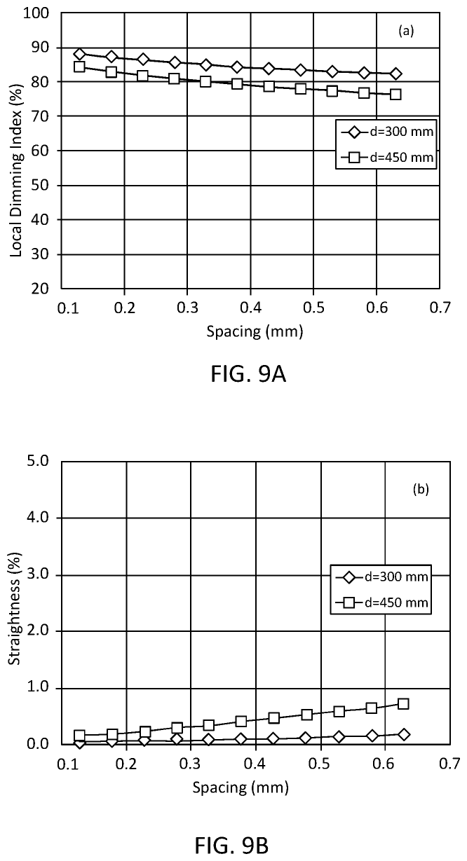

FIGS. 9A-B depict LDI and straightness, respectively, for 300 and 450 mm distances from the input edge as a function of the spacing between adjacent lenticular elongate microstructures. As shown in FIG. 9A, LDI decreases as the gap between adjacent elongate microstructures increases. Conversely, as shown in FIG. 9B, straightness increases as the gap between adjacent elongate microstructures increases. For the above parameters, good local dimming performance, as indicated by LDI greater than 80% and straightness less than 0.2%, can be achieved at a 450 mm distance when a 0.2 mm spacing or less is used between adjacent lenticular elongate microstructures.

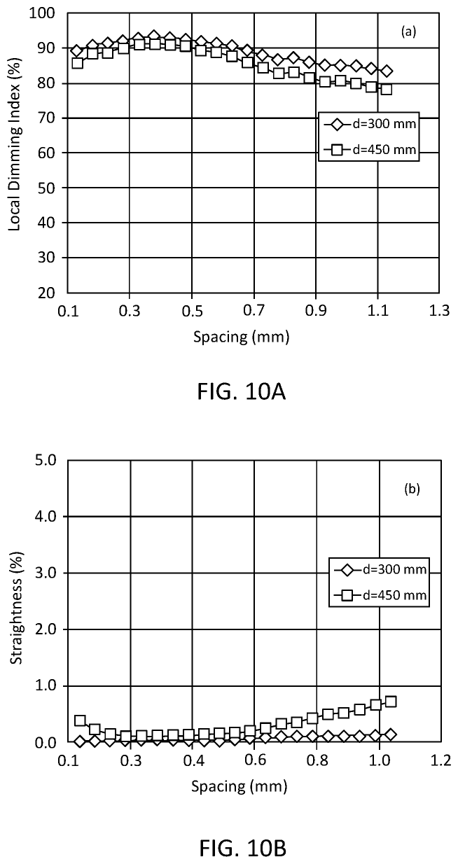

FIGS. 10A-B depict LDI and straightness, respectively, for a backlight unit comprising a glass sheet with lenticular elongate microstructures on a both major surface (see FIG. 6A). LDI and straightness were calculated for 300 and 450 mm distances from the input edge as a function of the gap distance between adjacent lenticular elongate microstructures. LDI and straightness are both improved for a glass sheet with lenticular structures on both sides (see FIGS. 10A-B) as compared to a glass sheet with lenticular structures on only one major surface (see FIGS. 9A-B). At a 450 mm distance from the light input edge and a 0.22 mm gap, LDI is 91% and straightness is 0.1%, indicating excellent local dimming performance. In addition, as compared to glass sheets with lenticular elongate microstructures on only one side, LDI greater than 80% can be achieved within a much wider gap range (0˜0.9 mm) between lenticular elongate microstructures for glass sheets with lenticular elongate microstructures on both major surfaces.

According to various embodiments, referring now to FIGS. 11A-15C, a first major surface 30 or a second major surface 32 of the glass sheet or both the first major surface 30 and the second major surface 32 may comprise plurality of light extraction features 80, 82. In some embodiments, the light extraction features are patterned. As used herein according to some embodiments, the term “patterned” is intended to denote that the plurality of light extraction features 80 are present on or in the surface of the glass in any given pattern or design, which may, for example, arranged, repetitive or non-repetitive, uniform or non-uniform. In some embodiments, the light extraction features 80, 82 may be located within the matrix of the LGP adjacent the surface, e.g., below the surface. For instance, the light extraction features may be distributed across the surface, e.g. as textural features making up a roughened or raised surface, or may be distributed within and throughout the LGP or portions thereof. Suitable methods for creating such light extraction features can include printing, such as inkjet printing, screen printing, microprinting, and the like, texturing, mechanical roughening, etching, injection molding, coating, laser damaging, or any combination thereof. Non-limiting examples of such methods include, for instance, acid etching a surface, coating a surface with TiO₂, and laser damaging the LGP by focusing a laser on a surface or within the matrix of the LGP.

In one or more embodiments, light extraction features 80, 82 may be formed, for example, by etching, wherein portions of first major surface 30 and/or second major surface 32 are coated with a suitable acid resistant material, for example by printing, and those portions of first major surface 30 and/or second major surface 32 where light extraction features are to be formed are maintained free of the acid resistant material. The so-coated surface may then be exposed to a suitable acid solution for a time and at a temperature necessary to etch the surface of the glass sheet to form channels or elongate microstructures having the desired depth or height and width, such as by dipping the glass sheet into the acid solution. In embodiments where only a single major surface of the glass sheet is etched, the opposite major surface may be covered entirely with acid resistant material. Additionally, the edge surfaces may also be coated with acid resistant material. The acid solution may include, for example HF, H₂SO₄, HCl, and combinations thereof. The etching method may, in certain embodiments, be applicable to glass compositions having a viscosity 11 and Young's modulus of elasticity E, wherein η/E<0.5 seconds.

In one or more embodiments, light extraction features 80, 82 may also be formed during a glass forming process, e.g., after formation of a glass ribbon but before cooling the ribbon to form a glass sheet. The glass ribbon prior to cooling may be viscous enough to be manipulated to create desired features. For instance, light extraction features 80, 82 can be formed via manipulation of direct contact forces, e.g., using embossing rolls. The rolls can be machined to create the desired light extraction features 80, 82 when impressed on the glass ribbon. In a viscous region of the glass forming process, the glass ribbon may be drawn through the rolls to create the desired channels or elongate microstructures. A transfer function may be used to describe the ratio between the machined features and resulting glass pattern which may, for example, account for contact forces, pulling forces, and viscous stretching or thermal expansion. The contact method may, in various embodiments, be applicable to glass compositions having a viscosity 11 and Young's modulus of elasticity E, wherein 0.0005 seconds <η/E<0.2 seconds.

In one or more embodiments, light extraction features 80, 82 may additionally be formed on a surface of the glass ribbon by providing regions of local heating and cooling relative to the rest of the ribbon. Such regions may be produced, in some embodiments, by impinging the glass ribbon with hot and/or cold gas, e.g., air. The aspect ratio (H/W) (H′/W′) of the elongate microstructures can be controlled by the method of heating or cooling, e.g., direct or indirect, by varying the orifice through which gas flows, and/or by varying the gas flow rate. Exemplary methods for locally heating or cooling the glass ribbon may employ, for instance, a hot sink tool, a lapinski tube, a doctari system located in a slide gate position, or other similar equipment. The local heating/cooling method may, in certain embodiments, be applicable to glass compositions having a viscosity 11 and Young's modulus of elasticity E, wherein 3.3×10⁻⁷ seconds <η/E<1.6×10⁻⁵ seconds.

FIGS. 11A and 11B show a top plan view of two major surfaces of a light guide plate comprising a glass sheet 28 comprising channels 60 that provide elongate microstructures on the first major surface 30 and light extraction features 80, 82 on the opposing second major surface 32.

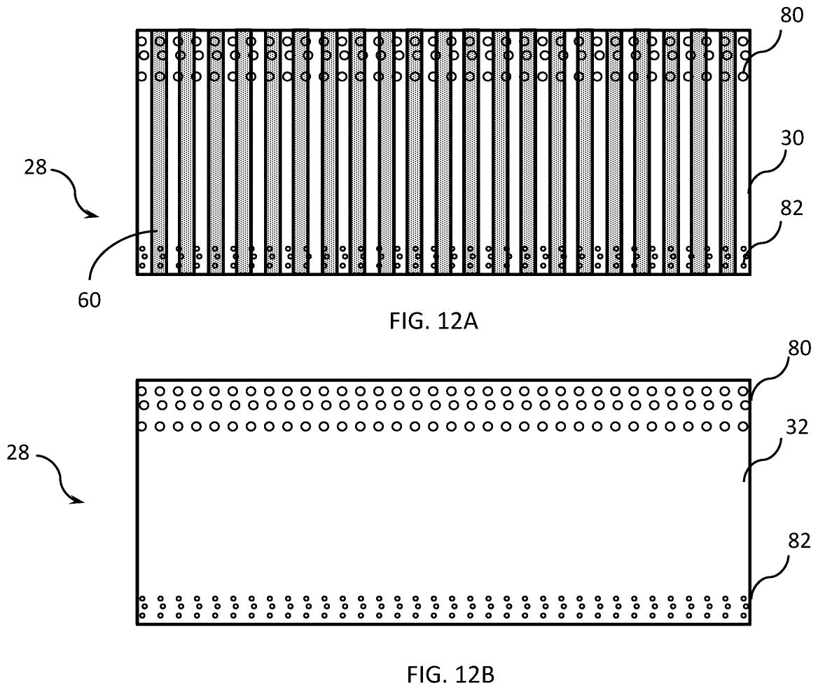

FIGS. 12A and 12B show a top plan view of two major surfaces of a light guide plate comprising a glass sheet 28 comprising channels 60 that provide elongate microstructures on the first major surface 30 and light extraction features 80, 82 on the first major surface 30 and the opposing second major surface 32.

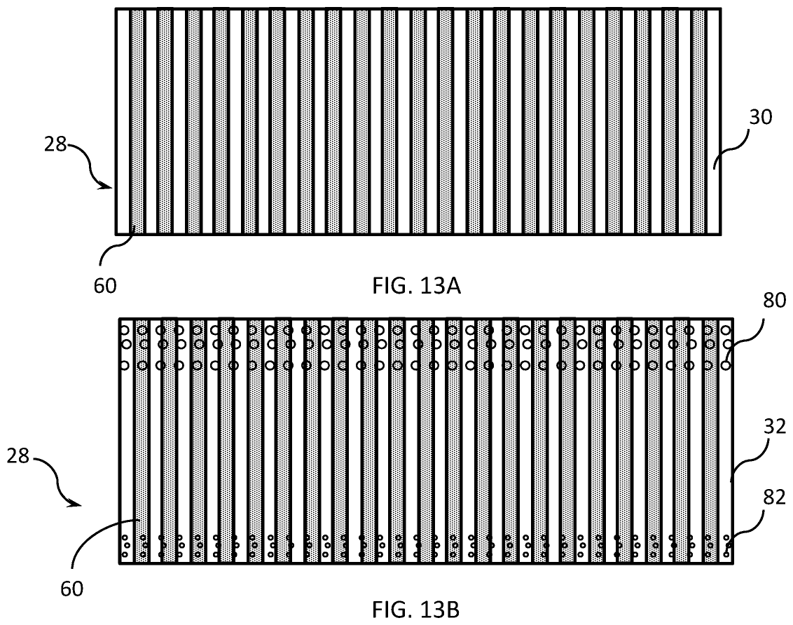

FIGS. 13A-B show two surface views of a light guide a top plan view of two major surfaces of a light guide plate comprising a glass sheet 28 comprising channels 60 that provide elongate microstructures on the first major surface 30 and the second major surface 32 and light extraction features 80, 82 on the second major surface 32.

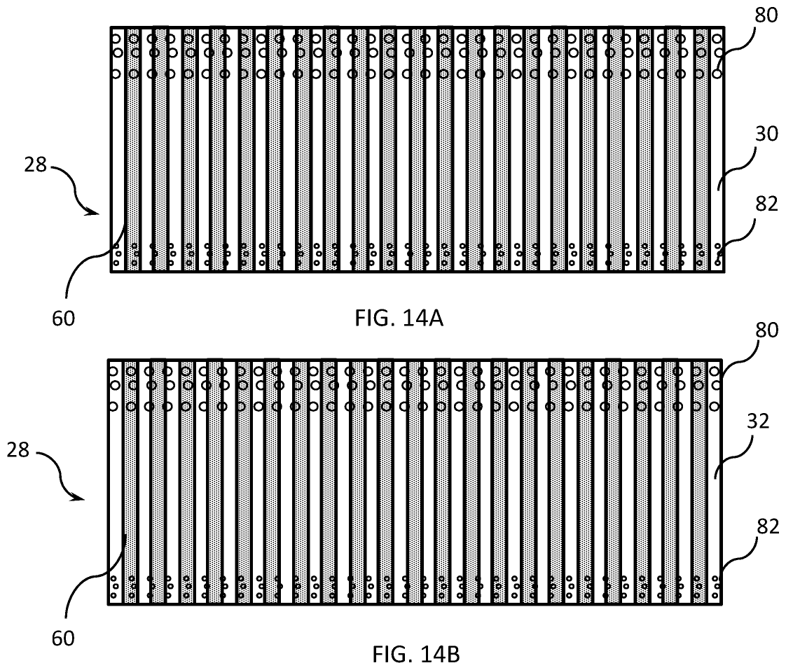

FIGS. 14A-B show a top plan view of two major surfaces of a light guide plate comprising a glass sheet 28 comprising channels 60 that provide elongate microstructures on the first major surface 30 and the second major surface 32 and light extraction features 80, 82 on the first major surface 30 and the second major surface 32.

According to one or more embodiments, the various processes for forming the light extraction features 80, 82, in particular, chemical etching or laser assisted chemical etching, can be used to form a properly shaped, sized, and patterned light extraction feature on the first major surface 30 and/or the second major surface 32 of the glass sheet. In some embodiments, the light extraction features comprise a plurality of discrete concave microstructures. In specific embodiments, the light extraction features comprise etched discrete microstructures.

In one or more embodiments, a glass article comprising a glass sheet 28 can be used as a light guide plate, which can comprise part of a backlight unit (BLU) according to the various embodiments described herein. In some embodiments, the light extraction features comprise a plurality of discrete concave microstructures arranged in a pattern. In some embodiments, the light extraction features are randomly arranged (or in a random arrangement) and not in a pattern. FIGS. 11A-14B show examples of patterns of light extraction features 80, 82. The discrete concave microstructures can be etched microstructures according to one or more embodiments. In some embodiments, the light extraction features 80, 82 are arranged in a pattern to produce a substantially uniform light output intensity across the first major surface of the at least one light guide plate. In some embodiments, the light extraction features in the form of a plurality of discrete concave microstructures include a shape that is selected from the group consisting of spherical, elliptical, cylindrical, prismatic, conical or pyramidal.

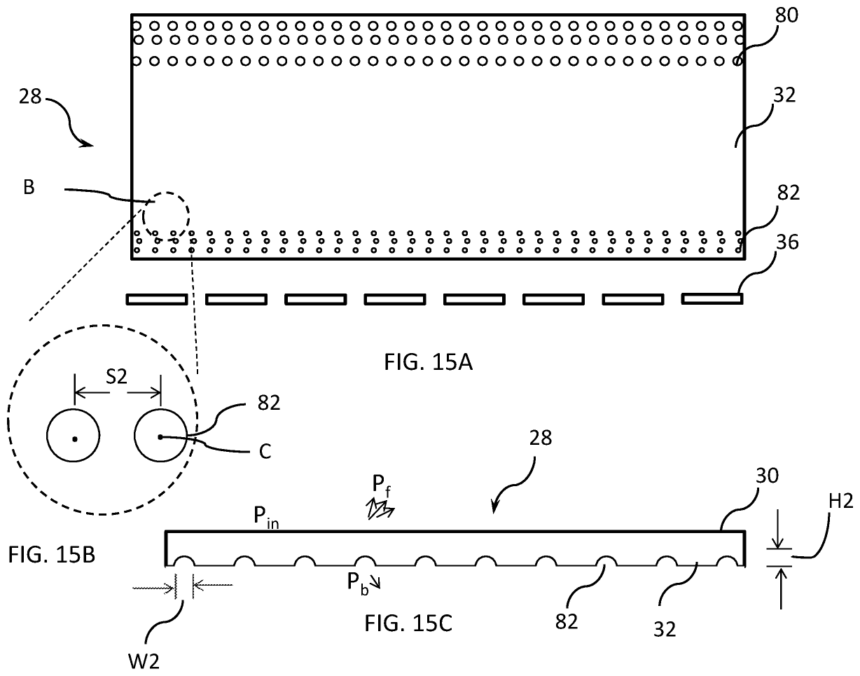

Referring now to FIGS. 15A-C, the parameters which can be used to optimize the light extraction of the light extraction features the concave microstructure extraction pattern to achieve uniform light extraction are width W2, spacing S2, depth H2, and/or a combination of any two or three of width, spacing and depth. In some embodiments, a ratio of W2 to H2 is in a range of from about 1 to about 150. In some embodiments, a ratio of W2 to H2 is in a range of from about 2 to about 100. In some embodiments, a ratio of W2 to S2 is in a range of from about 0.002-25, 0.01-10, 0.02-5. The embodiments shown in FIGS. 11B-14B show light extraction features 80, 82 which have different values for width W2, spacing S2 and depth H2. The spacing S2 can be fixed or varied depending on extraction pattern designs. For example, in FIG. 15A-C, light extraction features 82 adjacent to light emitting diodes (LEDs) 36 have a width W2 and a spacing S2 that is less than the width and the spacing of the light extraction features 80 further from the light emitting diodes 36. The light extraction features 80, 82 that can be in the form of concave microstructure size can be the same or slightly vary from center to two side edges. As shown in FIGS. 15A-C, the extraction pattern normally consists of multiple horizontal concave microstructures in lines. In one or more embodiments, to obtain uniform light extraction, the extraction strength of a horizontal concave microstructure line increases with the increase of its distance from light coupling edge closest to the LEDs. As shown in FIG. 15C, extraction factor is used to describe the extraction strength of a horizontal concave microstructure line n, which is defined as the ratio of the total light power extracted by the line n, (P_{f, n}+P_{b,n}) to total incident power to line n(P_{in,n}), where the first major surface 30 is the front and the second major surface 32 is the back of the device.

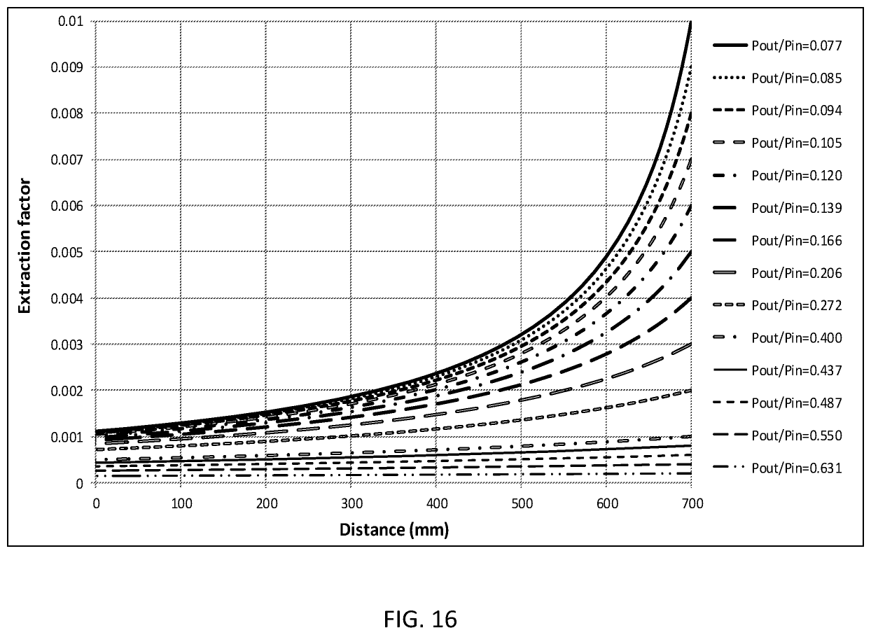

FIG. 16 shows the modeling curves of the extraction factor as a function of extraction line distance from input edge for achieving uniform light extraction in a LGP without reflector at the output edge for different power ratios of light transmitted through the LGP to the total light power at input edge (Pₒᵤₜ=Total light power at input edge, Pᵢₙ=total light power through the LGP, Pₒᵤₜ/Pᵢₙ). The light attenuation coefficient of the LGP is 0.3/m. Since the lower ratio of Pₒᵤₜ/Pᵢₙ, the less light is lost. As shown in FIG. 16, the low ratio of Pₒᵤₜ/Pᵢₙ requires the higher extraction factor at the output edge. To achieve Pₒᵤₜ/Pᵢₙ=10.5% (LGP light loss), the extraction factor of the last line should be 0.007.

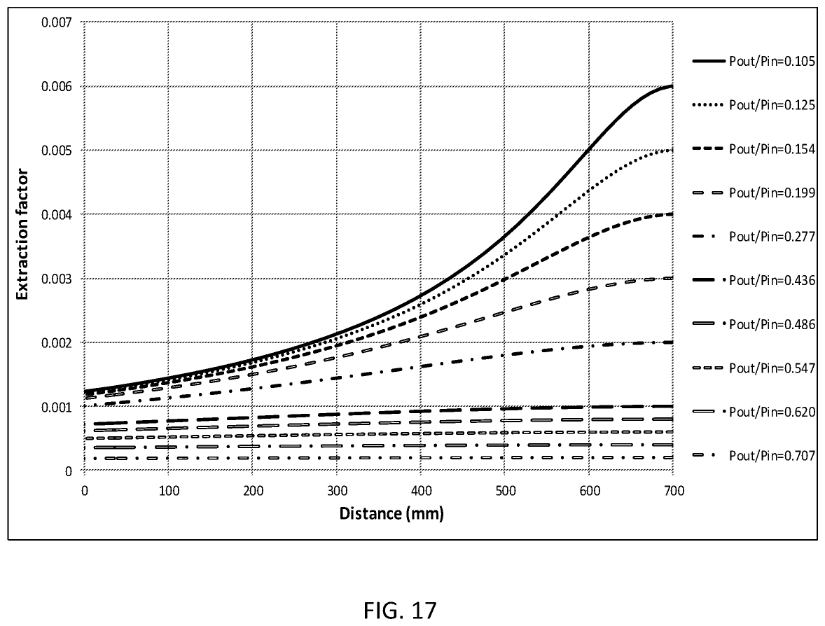

FIG. 17 shows the curves of the extraction factor as a function of extraction line distance from input edge for achieving uniform light extraction in a LGP with reflector at the output edge for different power ratios of light going through the LGP to input light (Pₒᵤₜ/Pᵢₙ). The output edge is specular reflector with a reflectivity of 95%. Because of light recycling due to the use output edge reflector, the light loss of the LGP will be around (Pₒᵤₜ/Pᵢₙ)². Compared with the first case (shown in FIG. 16), the use of the output edge reflector can significantly reduce the required value of the extraction factor near the output edge for the same amount of light loss. For example, to achieve LGP light loss being 7.7% (for Pₒᵤₜ/Pᵢₙ=0.277), the required extraction factor of the last line is only about 0.002. This will give much more operational room for making the extraction features.

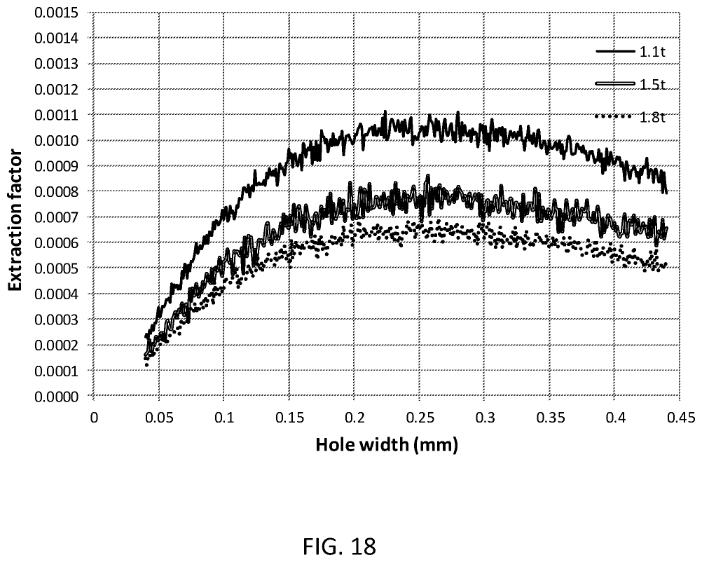

FIG. 18 shows the curve of extraction factor of one extraction line as a function of hole width for a LGP with different thickness (1.1, 1.5, or 1.8 mm). The holes have sphere shape. The hole depth is 20 micrometers, and the center-to-center spacing between two holes is 1.0 millimeters. The extraction factor increases with the increasing of the hole width, and is maximized at the hole width being ˜250 micrometers. It is also noted that the stronger light extraction is achieved in thinner LGP.

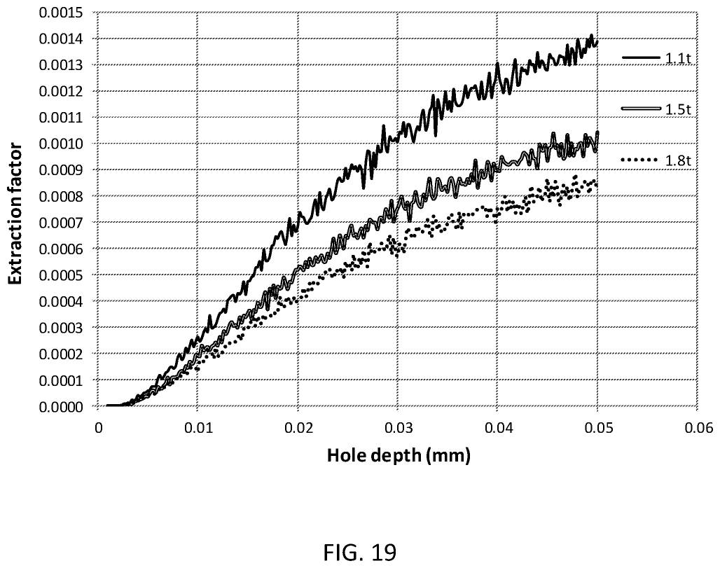

FIG. 19 shows the curve of extraction factor of one extraction line as a function of hole depth for a LGP with different thickness (1.1, 1.5, or 1.8 mm). The holes have a spherical shape. The hole width is 100 micrometers, and the center-to-center spacing between two holes is 1.0 millimeters. The extraction factor increases with the increasing of the hole depth. Again, the stronger light extraction is achieved in thinner LGP.

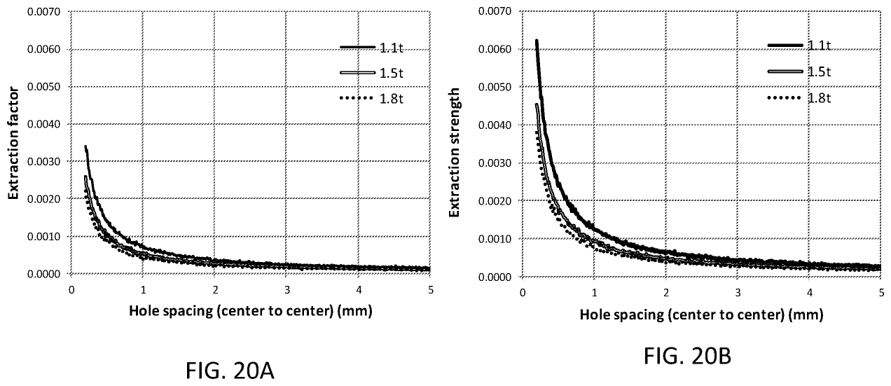

FIGS. 20A-B shows the curves of the extraction factor of one extraction line as a function of hole spacing for a LGP with different thickness (1.1, 1.5, or 1.8 millimeters) for a hole depth of 20 micrometers in FIG. 20A and a hole depth of 40 micrometers in FIG. 20B. The hole width is 100 micrometers. The extraction factor decreases with the increasing of the hole spacing. The stronger light extraction is achieved in thinner LGP. When the hole spacing is 0.2 millimeters, with a hole depth of 40 microns, the extraction factors for LGP thicknesses of 1.8, 1.5, and 1.1 millimeters are 0.0038, 0.0045, and 0.0062, respectively. LGP light loss less than 4% can be achieved with above extraction factors for all three different thickness LGPs in a 700 millimeter length LGP with 1 millimeter line to line spacing (see FIG. 17).

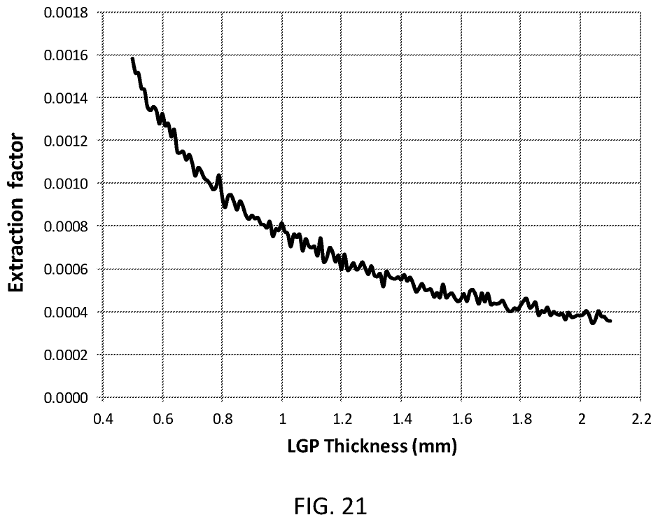

FIG. 21 shows the curve of the extraction factor of one extraction line as a function of LGP thickness in which hole depth, width, and spacing are 20 micrometers, 100 micrometers, and 1.0 millimeters, respectively. The extraction factor increased with the decreasing of LGP thickness.

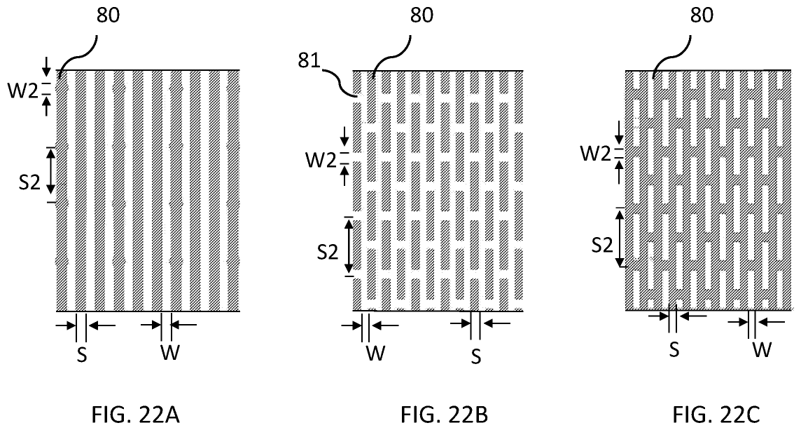

Various methods for forming light extraction features were described above. FIGS. 22A-C shows three exemplary embodiments of including lenticular lens features with the extraction pattern shown in FIG. 22A light extraction features 80 that are spherical and having a width as measured by a scanning electron microscope (SEM) W2 of 250 micrometers, a height H2 of 45 micrometers, and a W2 in a range of about 5-500 micrometers with a S2 pitch in a range of about 10 micrometers to 10 millimeters. FIG. 22B shows extraction features 80 as discontinuous lenticular structures having an opening 81 of about 200 micrometers and a pitch of about 450 micrometers (pitch refers to the center to center spacing for the holes/divots). FIG. 22C is a negative image of FIG. 22B.

One or more embodiments provide a method of manufacturing a glass article or a light guide plate comprising forming a plurality of channels in a first major surface of a glass sheet further comprising a second major surface opposite the first major surface, wherein adjacent channels of the plurality of channels are separated by a non-zero spacing S, at least one channel of the plurality of channels comprising a maximum depth H and a width W measured at one-half of the maximum height (H/2) and comprising a ratio W/H in a range from about 1 to about 15. The method further comprises forming light extraction features in at least one of the first major surface and the second major surface.

In an embodiment of the method, forming the plurality of channels and forming the light extraction features comprises masking and etching at least one of the first major surface and the second major surface. In embodiments of the method, the method can comprise simultaneously forming the plurality of channels and the plurality of light extraction features.

In one or more embodiments, etching is selected from the group consisting of acid etching, spray etching, HF acid etching, reactive ion etching, and wet etching. In one or more embodiments of the method, forming at least one of the plurality of channels and forming the light extraction features comprises masking and a process selected from the group consisting of sand blasting, airbrushing, embossing and water jetting.

In one or more embodiments of the method, W/H is in a range from about 2 to about 10, or in a range from about 2.5 to about 10, or in a range from about 0.1 to about 5. In one or more embodiments, W/S is in a range from about 0.1 to about 30, or in a range from about 0.25 to about 10, 0.5 to 2. In one or more embodiments, a maximum thickness T of the glass sheet is in a range from about 0.1 mm to about 2.1 mm.

In one or more embodiments of the method, a ratio of the maximum depth H of the at least one channel in the plurality of channels to a maximum thickness T of the glass sheet (H/T) ranges from about 0.01 to about 0.9, or from about 0.01 to about 0.5, or from about 0.0125 to about 0.3, or from about 0.02 to about 0.1.

According to one or more embodiments of the method, the glass sheet comprises

SiO₂ in a range from about 60 mol % to about 80 mol %, Al₂O₃ in a range from about 0 mol % to about 20 mol %, B₂O₃ in a range from about 0 mol % to about 15 mol %, and comprises an Fe concentration less than about a 50 ppm.

In some embodiments, forming the plurality of channels and forming the light extraction features comprises masking and etching at least one of the first major surface and the second major surface. In some embodiments, the method comprises simultaneously forming the plurality of channels and the plurality of light extraction features. In specific embodiments, a plurality of channels and a plurality of light extraction features are formed on one side of a glass sheet on a major surface in a single etch step.

The etching can comprise one or more of acid etching, HF acid etching, reactive ion etching, and wet etching. In some embodiments, forming at least one of the plurality of channels and forming the light extraction features comprises masking and a process selected from the group consisting of sand blasting, airbrushing, embossing and water jetting.

### EXAMPLES

Two sample substrates were manufactured. Each substrate was made with lenticular lines and uniform extraction features (spherical holes) on the same major surface of a piece of 8.5 inches×11 inches IRIS™ glass (available from Corning, Incorporated) having a thickness of 1.1 millimeters. The lines with extraction patterns were screen printed using an etch resist as the mask. The screen used for printing was a 360 mesh stainless steel screen with 150×150 micrometer lines and 250 micrometer dot patterns. EXAMPLE 1

A first sample used ESTS-3000 (available from Sun Chemical (www.sunchemical.com) as an etch resist, which was screen printed. A bare glass substrate of IRIS™ glass was pre-baked at 200° C., was cooled to room temperature, placed in the screen printer, and was printed using the ESTS-3000 screen-ink, diluted at 5% (wt.) with an aromatic solvent (ER-Solv18), available from Sun Chemical, using a squeegee speed of 5-50 cm/s, and screen-substrate gap of 2 mm. The pattern was post-baked at 140° C. for one hour before being subjected to the bath etcher where substrate was placed horizontally with gentle agitation (for 30-70 min) at a later time. Etching was conducted by spray etching a 10% HF-30% H₂SO₄ acid solution over the etch mask and rinsed with deionized water and mask cleaned off

### Example 2

A second sample used CGSN-XG77 ink available from Sun Chemical, which was screen printed as follows. A bare glass substrate of IRIS™ glass was pre-baked at 200° C., was cooled to room temperature, placed in the screen printer, and was printed using the CGSN-XG77 ink, using a squeegee speed of 10 cm/s, and screen-substrate gap of 2 mm. The pattern was post-baked at 140° C. for one hour before being subjected to the bath etcher where substrate was placed horizontally with gentle agitation (for 30-70 min) at a later time. Etching was conducted by spray etching a 10% HF-30% H₂SO₄ acid solution over the etch mask and rinsed with deionized water and mask cleaned off

The etched lenticular lines from the process using the ESTS-3000 ink were measured by a KLA-Tencor P011 stylus profilometer using a diamond stylus having about a 2 micrometer stylus and a 60 degree included angle, a 2 mg force constant, 100 Hz sampling rate, 50 micrometers/second scan rate and scan lengths up to 8 millimeters. The profilometer measured a depth of 58 microns of the etched lenticular lines on the substrate. Measurement of the etched lenticular lines obtained from the sample formed using the CGSN-XG77 ink showed a depth of 80 micron.

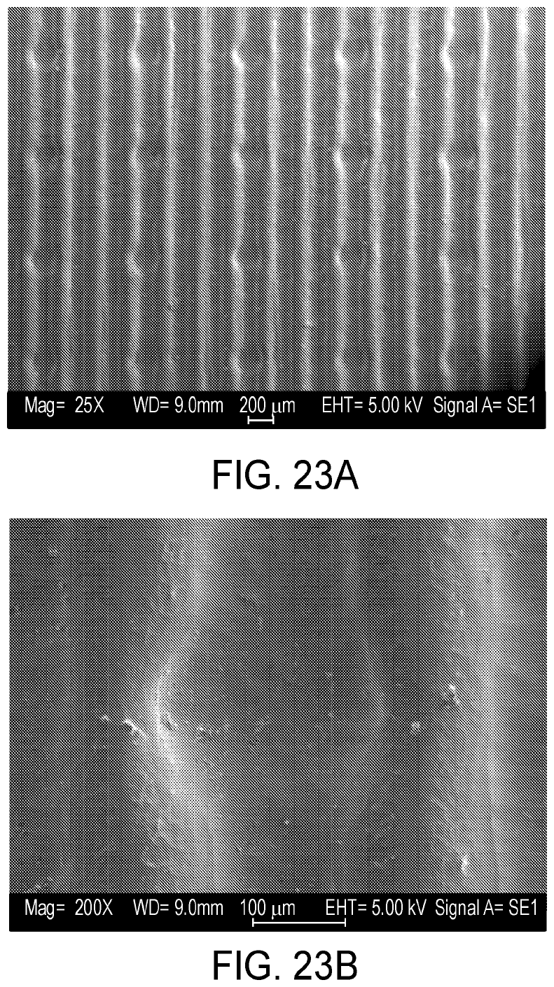

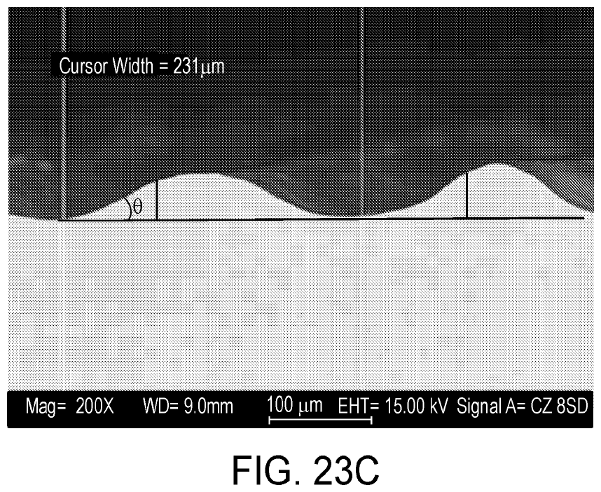

A scanning electron microscope was used to examine the lenticular channels formed on the glass substrates between the elongate microstructures. FIG. 23A shows a scanning electron microscope (SEM) photograph at 25 times magnification showing light extraction features embedded within the lenticular channels formed between the elongate microstructures formed in accordance with Example 1. FIG. 23B shows 200 times magnification SEM photo of a light extraction feature embedded within a channels formed between two elongate microstructures. FIG. 23C is a cross section of FIG. 23B at 200 times magnification.

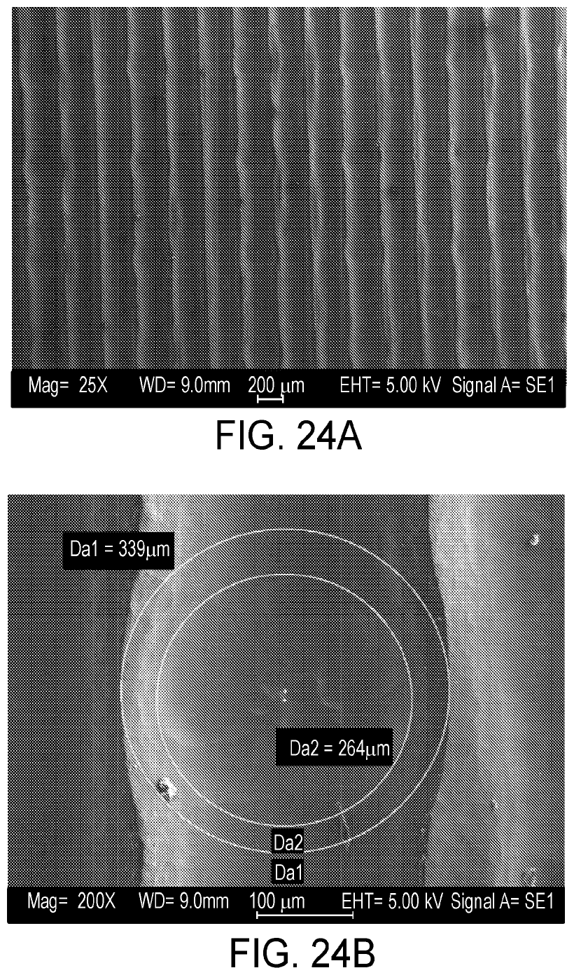

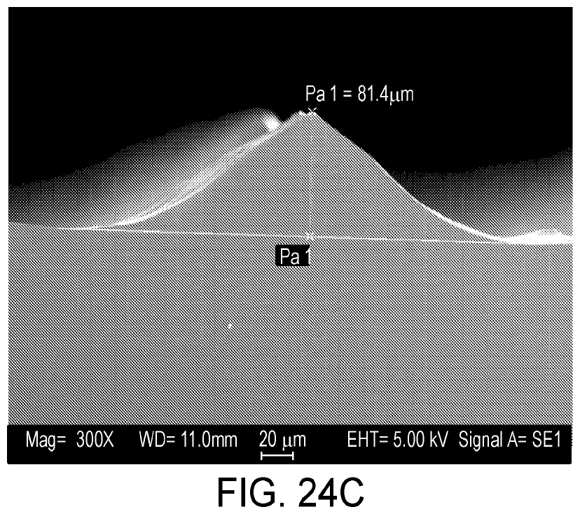

FIG. 24A shows an SEM photograph of the lenticular features made in accordance with Example 2, showing elongate microstructures, with channels between the elongate microstructures and light extraction features embedded in the channels. FIG. 24B is a 200× magnification SEM photograph of a light extraction feature embedded in a channel. The channels were measured to be about 264 micrometers in width, and the light extraction feature was measured to be 339 micrometers in diameter. FIG. 24C is a cross section of FIG. 24B, showing that the elongate microstructure had a depth of about 81.4 micrometers.

Thus, embodiments of the disclosure pertain to glass articles comprising a glass sheet, which can be used as an all glass light guide plate, and which can be part of a backlight unit as described herein. The backlight unit can be part of a display device. According to one or more embodiments, all glass light guide plate refers to a light guide plate in which the elongate microstructures that provide local dimming and the light extraction features are made from glass, and in some embodiments, the elongate microstructures and light extraction features are integrally formed with the glass article, glass substrate or glass sheet. Stated another way, in one or more embodiments, the light guide plate comprising elongate microstructures that provide local dimming and the light extraction features are a single monolithic glass article, and the light extraction features and elongate microstructures are not made from a material other than glass.

A first embodiment pertains to glass article comprising a glass sheet including a first major surface comprising a plurality of channels formed therein, wherein adjacent channels of the plurality of channels are separated by a non-zero distance W, at least one channel of the plurality of channels comprising a maximum depth H and a width S measured at one-half of the maximum depth (H/2) and comprising a ratio W/H in a range from about 1 to about 15; and the glass sheet further comprising a second major surface opposite the first major surface, and at least one of the first major surface and the second major surface comprising light extraction features formed therein.

In a second embodiment, W/H is in a range from about 2 to about 10. In a third embodiment, W/H is in a range from about 2.5 to about 10. In a fourth embodiment the first through third embodiments comprise W/S in a range from about 0.1 to about 5. In a fifth embodiment the first through third embodiments comprise W/S in a range from about 0.2 to about 3. In a sixth embodiment the first through third embodiments comprise W/S in a range from about 0.3 to about 1. In a seventh embodiment the first through sixth embodiments comprise a maximum thickness T of the glass sheet is in a range from about 0.1 mm to about 2.5 mm. In an eighth embodiment the seventh embodiment comprises T in a range from about 0.6 to about 2.1 mm. In a ninth embodiment the first through eighth embodiments are such that the light extraction features comprise a plurality of etched discrete microstructures.

In a tenth embodiment the first through ninth embodiments are such that the glass sheet comprises SiO₂ in a range from about 60 mol % to about 80 mol %, Al₂O₃ in a range from about 0 mol % to about 20 mol %, B₂O₃ in a range from about 0 mol % to about 15 mol %, and comprises an Fe concentration less than about a 50 ppm. In an eleventh embodiment the first through tenth embodiments are such that a ratio of the maximum depth H of the at least one channel in the plurality of channels to a maximum thickness T of the glass sheet (H/T) ranges from about 0.01 to about 0.9. In a twelfth embodiment, the eleventh embodiment is such that H/T ranges from about 0.01 to about 0.5.

In a thirteenth embodiment, the eleventh embodiment is such that H/T ranges from about 0.0125 to about 0.3. In a fourteenth embodiment, the eleventh embodiment is such that H/T range from about 0.02 to about 0.1. In a fifteenth embodiment, the first through fourteenth embodiments are such that the glass sheet further comprises a second major surface opposite the first major surface, the second major surface comprising a plurality of channels, wherein adjacent channels in the plurality of channels are separated by a non-zero spacing S′. In a sixteenth embodiment, the first through fifteenth embodiments are such that at least one channel in the plurality of channels is at least partially filled with a material comprising a refractive index at least about 10% lower than a refractive index of the glass sheet. In a seventh embodiment, the first through sixteenth embodiments are such that the at least one channel in the plurality of channels comprises a rectangular, arcuate, or trapezoidal cross sectional shape.

In an eighteenth embodiment, the seventeenth embodiment is such that the at least one channel comprises a trapezoidal cross sectional shape including a wall angle Θ ranging from greater than about 90° to less than about 160°. In a nineteenth embodiment, the first through eighteenth embodiments are such that the light extraction features comprise a plurality of discrete concave microstructures arranged in a pattern. In a twentieth embodiment, the first through nineteenth embodiments are such that the light extraction features are in a random arrangement. In a twenty-first embodiment, the nineteenth through twentieth embodiments are such that the discrete concave microstructures are integrally formed in the glass sheet. In a twenty-second embodiment, the twenty-first embodiment is such that the discrete concave microstructures are etched microstructures. In a twenty-third embodiment, the first through twenty-second embodiments are such that the plurality of discrete concave microstructures includes a shape that is selected from the group consisting of spherical, elliptical, cylindrical, prismatic, conical or pyramidal.

In a twenty-fourth embodiment, the nineteenth through twenty-third embodiments are such that each discrete concave microstructure has a depth H2 and a width W2, and wherein a ratio of W2 to H2 is in a range of from about 1 to about 150. In a twenty-fifth embodiment, the first through twenty-fourth embodiments are such that each discrete concave microstructure has a depth H2 and a width W2, and wherein a ratio of W2 to H2 is in a range of from about 2 to about 100. In a twenty-sixth embodiment, the nineteenth through twenty-third embodiments are such that adjacent discrete concave microstructures have a center, and a center-to-center spacing of S2, and a ratio of W2 to S2 is in a range of from about 0.002 and 25. In a twenty-seventh embodiment, the first through twenty-sixth embodiments are such that the channels are on the first major surface and the light extraction features are on the second major surface. In a twenty-eighth embodiment, the first through twenty-sixth embodiments are such that the channels are on the first major surface or the second major surface and the light extraction features are on a major surface that comprises the channels.

In a twenty-ninth embodiment, the first through twenty-sixth embodiments are such that the channels are on the first major surface and the second major surface and the light extraction features are on the first major surface and the second major surface. In a thirtieth embodiment, the first through twenty-ninth embodiments are such that the light extraction features are arranged in a pattern to produce a substantially uniform light output intensity across the first major surface of the glass sheet. In a thirty-first embodiment, the first through thirtieth embodiments are such that the glass article comprises a light guide plate. In a thirty-second embodiment, the first through thirtieth embodiments are such that the glass article comprises a backlight unit. In a thirty-third embodiment any one of the first through thirty-second embodiments are such that the glass article comprises a display device.

A thirty-fourth embodiment pertains to a backlight unit, comprising a glass article in accordance with any of the first through thirty-first embodiments; and a plurality of light emitting diodes arranged in an array along at least one edge surface of the glass sheet. A thirty fifth embodiment pertains to a LCD display device comprising the backlight unit of the thirty-fourth embodiment.

A thirty sixth embodiment pertains to a method of manufacturing a light guide plate comprising forming a plurality of channels in a first major surface of a glass sheet further comprising a second major surface opposite the first major surface, wherein adjacent channels of the plurality of channels are separated by a non-zero distance W, at least one channel of the plurality of channels comprising a maximum depth H and a width S measured at one-half of the maximum depth (H/2) and comprising a ratio W/H in a range from about 1 to about 15; and forming a plurality of light extraction features in at least one of the first major surface and the second major surface. In a thirty-seventh embodiment, the thirty-sixth embodiment is such that forming the plurality of channels and forming the light extraction features comprises masking and etching at least one of the first major surface and the second major surface. In a thirty-eighth embodiment, the thirty-sixth or thirty-seventh embodiments comprise simultaneously forming the plurality of channels and the plurality of light extraction features. In a thirty-ninth embodiment, the thirty-seventh or thirty-eighth embodiments comprise etching is selected from the group consisting of acid etching, HF acid etching, reactive ion etching, and wet etching.

In a fortieth embodiment, the thirty-sixth through thirty-ninth embodiments comprise forming at least one of the plurality of channels and forming the light extraction features comprises masking and a process selected from the group consisting of sand blasting, airbrushing, embossing and water jetting. In a forty-first embodiment, the thirty-sixth through fortieth embodiments are such that W/H is in a range from about 1 to about 15. In a forty-second embodiment, the thirty-sixth through fortieth embodiments are such that W/S is in a range from about 0.1 to about 30. In a forty-third embodiment, the thirty-sixth through forty-second embodiments are such that a maximum thickness T of the glass sheet is in a range from about 0.1 mm to about 2.5 mm. In a forty-fourth embodiment, the forty-third embodiment is such that a ratio of the maximum depth H of the at least one channel in the plurality of channels to a maximum thickness T of the glass sheet (H/T) ranges from about 0.01 to about 0.9. In a forty-fifth embodiment, the forty-fourth embodiment is such that H/T ranges from about 0.01 to about 0.5. In a forty-sixth embodiment, the forty-fourth embodiment is such that H/T ranges from about 0.0125 to about 0.3. In a forty-seventh embodiment, the forty-fourth embodiment is such that H/T ranges from about 0.02 to about 0.1. In a forty-eighth embodiment any of the thirty-sixth through forty seventh embodiments are such that the glass sheet comprises SiO₂ in a range from about 60 mol % to about 80 mol %, Al₂O₃ in a range from about 0 mol % to about 20 mol %, B₂O₃ in a range from about 0 mol % to about 15 mol %, and comprises an Fe concentration less than about a 50 ppm.

Ranges expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein, for example up, down, right, left, front, back, top, bottom are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A glass article comprising a glass sheet including a first major surface comprising a plurality of channels formed therein, wherein adjacent channels of the plurality of channels are separated by a non-zero distance W, at least one channel of the plurality of channels comprising a maximum depth H and a width S measured at one-half of the maximum depth (H/2) and comprising a ratio W/H in a range from about 1 to about 15; and
the glass sheet further comprising a second major surface opposite the first major surface, at least one of the first major surface or the second major surface comprising light extraction features formed therein.

2. The glass article according to claim 1, wherein W/H is in a range from about 2 to about 10.

3. (canceled)

4. The glass article according to claim 2, wherein W/S is in a range from about 0.1 to about 5.

5. (canceled)

6. (canceled)

7. The glass article according to claim 1, wherein a maximum thickness T of the glass sheet is in a range from about 0.1 mm to about 2.5 mm.

8. (canceled)

9. The glass article according to claim 1, wherein the light extraction features comprise a plurality of etched discrete microstructures.

10. The glass article according to claim 1, wherein the glass sheet comprises SiO₂ in a range from about 60 mol % to about 80 mol %, Al₂O₃ in a range from about 0 mol % to about 20 mol %, B₂O₃ in a range from about 0 mol % to about 15 mol %, and comprises an Fe concentration less than about a 50 ppm.

11. The glass article according to claim 1, wherein a ratio of the maximum depth H of the at least one channel in the plurality of channels to a maximum thickness T of the glass sheet (H/T) ranges from about 0.01 to about 0.9.

12. The glass article according to claim 11, wherein H/T ranges from about 0.01 to about 0.5.

13. (canceled)

14. The glass article according to claim 11, wherein H/S ranges from about 0.02 to about 0.1.

15. The glass article according to claim 1, wherein the glass sheet further comprises a second major surface opposite the first major surface, the second major surface comprising a plurality of channels, wherein adjacent channels in the plurality of channels are separated by a non-zero spacing S′.

16. The glass article according to claim 1, wherein at least one channel in the plurality of channels is at least partially filled with a material comprising a refractive index at least about 10% lower than a refractive index of the glass sheet.

17. The glass article according to claim 1, wherein the at least one channel in the plurality of channels comprises a rectangular, arcuate, or trapezoidal cross-sectional shape.

18. The glass article according to claim 17, wherein the at least one channel comprises a trapezoidal cross-sectional shape including a wall angle Θ ranging from greater than about 90° to less than about 160°.

19. The glass article according to claim 1, wherein the light extraction features comprise a plurality of discrete concave microstructures arranged in a pattern.

20. (canceled)

21. The glass article according to claim 19, wherein the discrete concave microstructures are integrally formed in the glass sheet.

22. The glass article according to claim 21, wherein the discrete concave microstructures are etched microstructures.

23. (canceled)

24. The glass article according to claim 19, wherein each discrete concave microstructure has a depth H2 and a width W2, and wherein a ratio of W2 to H2 is in a range of from about 1 to about 150.

25. (canceled)

26. The glass article according to claim 19, wherein adjacent discrete concave microstructures have a center, and a center-to-center spacing of S2, and a ratio of W2 to S2 is in a range of from about 0.002 and 25.

27.-35. (canceled)

36. A method of manufacturing a light guide plate comprising:
forming a plurality of channels in a first major surface of a glass sheet further comprising a second major surface opposite the first major surface, wherein adjacent channels of the plurality of channels are separated by a non-zero distance W, at least one channel of the plurality of channels comprising a maximum depth H and a width S measured at one-half of the maximum depth (H/2) and comprising a ratio W/H in a range from about 1 to about 15; and
forming a plurality of light extraction features in at least one of the first major surface or the second major surface.

37. The method of claim 36, wherein forming the plurality of channels and forming the light extraction features comprises masking and etching at least one of the first major surface or the second major surface.

38. The method of claim 36, further comprising simultaneously forming the plurality of channels and the plurality of light extraction features.

39. The method of claim 37, wherein the etching is selected from the group consisting of acid etching, HF acid etching, reactive ion etching, and wet etching.

40. The method of claim 36, wherein forming at least one of the plurality of channels and forming the light extraction features comprises masking and a process selected from the group consisting of sand blasting, airbrushing, embossing and water jetting.

41. The method of claim 36, wherein W/H is in a range from about 1 to about 15.

42. The method of claim 36, wherein W/S is in a range from about 0.1 to about 30.

43. The method of claim 36, wherein a maximum thickness T of the glass sheet is in a range from about 0.1 mm to about 2.5 mm.

44. The method according to claim 43, wherein a ratio of the maximum depth H of the at least one channel in the plurality of channels to a maximum thickness T of the glass sheet (H/T) ranges from about 0.01 to about 0.9.

45. The method according to claim 44, wherein H/T ranges from about 0.01 to about 0.5.

46. The method according to claim 44, wherein H/T ranges from about 0.0125 to about 0.3.

47. (canceled)

48. The method of claim 36, wherein the glass sheet comprises SiO₂ in a range from about 60 mol % to about 80 mol %, Al₂O₃ in a range from about 0 mol % to about 20 mol %, B₂O₃ in a range from about 0 mol % to about 15 mol %, and comprises an Fe concentration less than about a 50 ppm.
